(19) United States
(12) Patent Application Publication
(10) Pub. No.: US 2011/0238761 A1
(43) Pub. Date: Sep. 29, 2011

(54) CHAT RELAY SERVER AND CHAT TERMINAL USED IN CHAT SYSTEM, METHODS OF CONTROLLING SAME, AND CHAT SYSTEM

(75) Inventor: Ryutaro MIZOKAMI, Tokyo (JP)

(73) Assignee: FUJIFILM CORPORATION, Tokyo (JP)

(21) Appl. No.: 13/016,778

(22) Filed: Jan. 28, 2011

(30) Foreign Application Priority Data
Mar. 29, 2010 (JP) 2010-075950

(51) Int. Cl. G06F 15/16

(52) U.S. Cl. 709/206

(57) ABSTRACT

A text-data chat message transmitted from a client terminal (21) is received by a chat server (30) via a chat relay system (10). When the chat message is distributed from the chat server (30) toward chat participating users, the chat message is converted to image data by an image converter (10C) of the chat relay system (10) and a chat message image is transmitted to client terminals (21, 22, . . . ).

### BACKGROUND OF THE INVENTION

1. Field of the Invention

This invention relates to a chat relay server and chat terminal used in a chat system, methods of controlling these and a chat system that includes the chat relay server and chat terminal.

2. Description of the Related Art

Active communication within an organization is of paramount importance. As for means of communicating within an organization, use is made of a telephone, e-mail, bulletin board system and chat, etc., in accordance with the particular application. Among these means, chat makes it possible for many people to engage in real-time conversation at one time and to send and receive files.

There is an increasing number of organizations in which the sharing of information is enhanced and the efficiency of business improved by making it possible to view in-house e-mail and attached files from the road through use of a portable terminal.

The specification of Japanese Patent Application Laid-Open No. 2003-32310 (Patent Document 1) describes a relay server that implements communication among network devices within a plurality of local systems via the Internet and makes it possible for other network devices to participate in such communication. The specification of Japanese Patent Application Laid-Open No. 2001-256137 (Patent Document 2) describes a system for sharing knowledge by the screen sharing of data and information in electronic form. Data and information in electronic form is encrypted to enhance security.

Patent Document 1 has room for improvement since real-time information cannot be shared at client devices. The system of Patent Document 2 places a great burden on its CPU owing to the encryption and decryption of information. With a portable terminal of diminished CPU power, therefore, it is likely that document viewing and the like will not be able to proceed smoothly (seamlessly).

### SUMMARY OF THE INVENTION

An object of the present invention is to so arrange it that messages and files can be sent and received securely and in real-time.

The present invention provides a chat relay system, which is provided between a chat terminal and a chat server, for relaying a chat message transmitted from the chat terminal toward the chat server and a chat message transmitted from the chat server toward the chat terminal, the system comprising: an image converter for converting a text-data chat message, which is transmitted from the chat server to the chat terminal, to an image-data chat message image; and an image transmission control unit for transmitting image data, which represents the chat message image obtained by data conversion performed by the image converter, to the chat terminal in place of the text data representing the chat message. The expression “between a chat terminal and a chat server” means that irrespective of the data sent and received between the chat terminal and chat server on a network, the data is capable of being sent and received via the chat relay system.

The present invention also provides a method suited to control of the above-described chat relay system. Specifically, the invention provides a method of controlling a chat relay system, which is provided between a chat terminal and a chat server, for relaying a chat message transmitted from the chat terminal toward the chat server and a chat message transmitted from the chat server toward the chat terminal, the chat relay system including an image converter and an image transmission control unit and the method comprising the steps of: the image converter converting a text-data chat message, which is transmitted from the chat server to the chat terminal, to an image-data chat message image; and the image transmission control unit transmitting image data, which represents the chat message image obtained by data conversion performed by the image converter, to the chat terminal in place of the text data representing the chat message.

The chat relay system according to the present invention relays a chat message sent and received between a chat terminal and a chat server. A chat message transmitted from the chat terminal to the chat server is transmitted from the chat server to the chat terminals of multiple users participating in the chat (users for whom chat participation processing has been completed). The sending and receiving of chat messages between a chat terminal and the chat server may be performed by any of polling, Comet and paging schemes. In any case, a chat message that has been transmitted from the chat terminal is transmitted from the chat server to oneself (the user who transmitted the chat message) and to the chat terminals of the other chat participating users substantially in real-time (accompanied by almost no time delay).

In accordance with the present invention, a text-data chat message transmitted from the chat server toward the chat terminal is converted to an image-data chat message image and the image data representing the chat message image is transmitted to the chat terminal. In the chat terminal, the chat message (the content of conversations among multiple users) is displayed in its entirety as an image represented by the image data. Since no text data is included, the content of the chat message cannot be revised or altered. Further, since extraction of text data that is possible in case of a display based upon text data (namely the copying and pasting, etc., of text data in character areas) cannot be achieved, there is little possibility of leakage of information and there is a high degree of security. Since data encryption and decryption are unnecessary, there is little processing load upon the chat terminal and it is possible to display chat message images rapidly.

In an embodiment, the image data is associated with link information and the image converter converts, to an image-data document image, a document file containing text data transmitted from an external device toward the chat terminal in accordance with this link information. The image transmission control unit transmits the image data of the document image obtained by the data conversion by the image converter to the chat terminal in place of the text data representing the document file. Thus, even in a case where a document file (created by word processing software or by presentation software or the like) is transmitted to the chat terminal from an external device that stores this document file, the document file is transmitted to the chat terminal upon being converted to an image and put into the form of a document image. Revisions and alterations, etc., cannot be made and text data cannot be extracted not only with regard to a chat message but also with regard to a document file.

A chat terminal according to the present invention is used in a chat system including the chat terminal, a chat server and a chat relay system, which is provided between the chat terminal and the chat server, for relaying a chat message transmitted from the chat terminal toward the chat server and a chat message transmitted from the chat server toward the chat terminal, the chat terminal comprising: a chat message transmitting device (means) for transmitting a text-data chat message; a chat message image receiving device (means) for receiving chat message image data, which represents a chat message image that is the result of converting a text-data chat message to an image, obtained by data conversion processing in the chat relay system with regard to a chat message transmitted from the chat server toward the chat terminal; and a chat message image display device (means) for displaying the chat message image represented by the chat message image data received by the chat message image receiving device.

The present invention also provides a method suited to control of the above-described chat terminal. Specifically, the invention provides a method of controlling a chat terminal used in a chat system including the chat terminal, a chat server and a chat relay system, which is provided between the chat terminal and the chat server, for relaying a chat message transmitted from the chat terminal toward the chat server and a chat message transmitted from the chat server toward the chat terminal, the method comprising the step of controlling the chat terminal so as to: transmit a text-data chat message; receive chat message image data, which represents a chat message image that is the result of converting a text-data chat message to an image, obtained by data conversion processing in the chat relay system with regard to a chat message transmitted from the chat server toward the chat terminal; and display the chat message image represented by the chat message image data received.

In accordance with the present invention, a chat message is displayed at the chat terminal not as a text-data chat message but as a chat message image represented by image data. The content of the chat message cannot be revised or altered, etc., as mentioned above. Further, since extraction of text data that is possible in case of a display based upon text data (namely the copying and pasting, etc., of text data in character areas) cannot be achieved, there is little possibility of leakage of information and there is a high degree of security.

In an embodiment, the chat message transmitting device attaches link information to and transmits this information together with the text-data chat message. The chat message image receiving device receives chat message image data representing a chat message image that is the result of converting the text-data chat message to an image, and the link information, which has been associated with the chat message image data, obtained when the link information has been attached to the text-data chat message in the chat relay system. In response to receipt of the chat message image data with which the link information has been associated, the chat message image display device displays the chat message image, which is represented by the chat message image data, in clickable fashion in such a manner that the chat message transmitting device will transmit data that is in accordance with the link information when the chat message image is clicked.

When the link information is transmitted together with the text-data chat message, an image based upon image data representing the content of this chat message is displayed on the chat terminal in clickable fashion. By clicking this image, data (e.g., a message or the like instructing transmission of a specific document file) in accordance with the link information accompanying the image data is transmitted by the chat message transmitting device. Thereafter, in the manner described above, the document file specified by the link information is converted to an image and the image is transmitted to the chat terminal and displayed in viewable fashion. Thus it is possible to implement the sending and receiving of a chat message as if the chat message were accompanied by an attached file.

The present invention also provides a chat system including the above-described chat terminal, the chat relay system, a chat server and a file server. Specifically, the chat system according to the present invention comprises: (a) a chat terminal having an input unit for accepting input of a text-data chat message, a chat message transmitting device (means) for transmitting the text-data chat message received from the input unit, an image data receiving device (means) for receiving image data, and a display unit for displaying an image represented by the image data received by the image data receiving device; (b) a chat server having a chat message receiving device (means) for receiving a text-data chat message transmitted from the chat terminal, and a chat message distributing device (means) for distributing the chat message, which has been received by the chat message receiving device, to a chat terminal of a chat participating user; (c) a file server having a storage device for storing a document file; and (d) a chat relay system for relaying transmission and reception of data between the chat terminal and chat server and transmission and reception of data between the chat terminal and file server, wherein the chat relay system includes an image converter for converting a text-data chat message, which is transmitted from the chat server to the chat terminal, to an image-data chat message image, and for converting a document file, which is transmitted from the file server to the chat terminal, to an image-data document image. The chat message and document file are transmitted to the chat terminal and are displayed at the chat terminal as images in their entirety by image data. Since no text data is included, the content of the chat message cannot be revised or altered.

In an embodiment, the chat server and file server are connected with the chat relay system by a dedicated network (e.g., a VPN). Communication between the chat relay system and the chat server and file server is made more secure (the secrecy thereof is enhanced). The chat server and file server may be connected by a LAN so as to be capable of communicating with each other.

In another embodiment, the chat server is included in the chat relay system. By arranging it so that the transmission and reception of data between the chat server and chat relay system is not transmission and reception of data through a network, the security (secrecy) of chat messages is enhanced further.

As mentioned above, the reception and transmission of a chat message between the chat terminal and the chat server may employ any scheme from among a polling scheme, in which the chat terminal transmits a new-message transmit request to the chat server repeatedly at prescribed time intervals and the chat server transmits a reply to the request to the chat terminal whenever it receives the transmit request; a Comet scheme, in which a new-message transmit request transmitted from the chat terminal to the chat server continues to be held until the chat server is capable of replying to the request, and the chat server transmits the reply to the chat terminal at a timing at which the reply to the request has become possible; and a paging scheme, in which the chat server, in response to receipt of a text-data chat message transmitted from the chat terminal, transmits paging data to the chat terminal of the chat participating user, and a new-message transmit request is transmitted from the chat terminal to the chat server in response to receipt of the paging data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the overall configuration of a chat system;

FIG. 2 is a block diagram illustrating the hardware configuration of a chat relay system;

FIG. 3 illustrates a user information table in a chat relay system;

FIG. 4 illustrates a user information table in a chat server;

FIG. 5 illustrates a room entry management information table;

FIG. 6A illustrates a file storage table and FIG. 6B a user information table of a file server;

FIG. 7 illustrates the external appearance of a client terminal;

FIG. 8 is a sequence diagram illustrating processing executed by a chat system in log-in processing;

FIG. 9 is a sequence diagram illustrating processing executed by a chat system in log-in processing;

FIG. 10 is a sequence diagram illustrating processing executed by a chat system in log-in processing;

FIG. 11 illustrates a log-in information input screen;

FIG. 12 illustrates a chat room list screen;

FIG. 13 is a sequence diagram illustrating processing executed by a chat system in chat room creation processing;

FIGS. 14A and 14B illustrate chat room list screens;

FIGS. 15A and 15B illustrate chat room list screens;

FIG. 16 is a sequence diagram illustrating processing executed by a chat system in chat room entry processing;

FIG. 17 illustrates a basic chat screen;

FIG. 18 is a sequence diagram illustrating processing executed by a chat system in message creation, transmission and reception processing;

FIGS. 19A and 19B illustrate basic chat screens;

FIGS. 20A and 20B illustrate basic chat screens;

FIG. 21 is a sequence diagram illustrating processing executed by a chat system in view file selection processing;

FIG. 22 illustrates a basic chat screen;

FIG. 23 illustrates a file server screen;

FIGS. 24 to 28 illustrate basic chat screens;

FIG. 29 is a sequence diagram illustrating processing executed by a chat system in file view processing;

FIG. 30 illustrates a basic chat screen;

FIG. 31 illustrates a file display screen;

FIG. 32 is a sequence diagram illustrating processing executed by a chat system in processing for changing a display at a client terminal;

FIGS. 33A, 33B, 33C and 33D illustrate file display screens;

FIG. 34 is a block diagram illustrating the overall configuration of another example of a chat system;

FIG. 35 is a block diagram illustrating the overall configuration of another example of a chat system;

FIG. 36 is a sequence diagram illustrating an example of a scheme for sending and receiving messages in a chat system;

FIG. 37 is a sequence diagram illustrating another example of a scheme for sending and receiving messages in a chat system; and

FIG. 38 is a sequence diagram illustrating a further example of a scheme for sending and receiving messages in a chat system.

### DESCRIPTION OF THE PREFERRED EMBODIMENTS

Preferred embodiments of the present invention will now be described in detail with reference to the drawings.

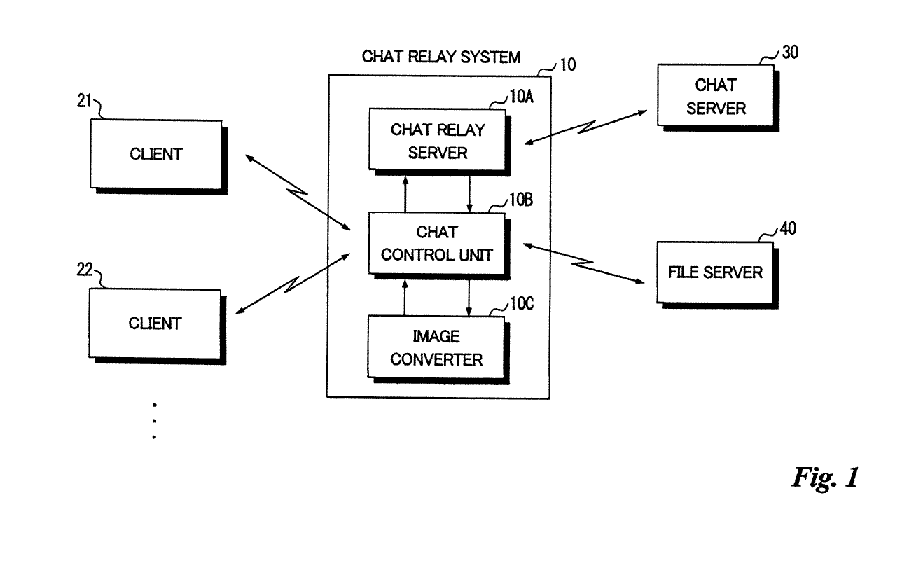

FIG. 1 is a block diagram illustrating the overall configuration of a chat system that includes a chat relay system.

The chat system enables multiple users who are visiting (participating) in a chat room to exchange messages (text) and to view documents represented by document files. It is possible for a large number of people to engage in real-time conversion (input and display of text) and document perusal, etc.

The chat system of this embodiment is constituted by a plurality of client terminals 21, 22, . . . used by chat users; a chat server 30 for managing the chat users, managing the chat room and transmitting (distributing) messages to the chat users; a file server 40 for providing document files capable of being viewed by the chat users; and a chat relay system 10 for relaying data sent and received between the client terminals 21, 22, . . . and the chat server 30 and file server 40. The client terminals 21, 22, . . . , chat relay system 10, chat server 30 and file server 40 are interconnected by a network (the Internet, etc.) so as to be capable of communicating with one another. Although the details will be described later, the client terminals 21, 22, . . . do not send and receive data to and from the chat server 30 and file server 40 directly but always through the intermediary of the chat relay system 10.

The chat relay system 10 includes a chat relay server 10A, a chat control unit 10B and an image converter 10C.

The chat relay server 10A sends and receives data to and from the chat server 30. The chat control unit 10B receives data transmitted from the client terminals 21, 22, . . . , transmits data to the client terminals 21, 22, . . . and executes processing for authenticating chat users. The image converter 10C executes processing such as processing for applying an image conversion to data transmitted to the client terminals 21, 22, . . . . The image conversion processing is processing which, when text data has been transmitted from chat server 30 as data to be transmitted to client terminal 21, converts the characters represented by this text data to an image (to jpg data, for example). In the chat system of this embodiment, data transmitted from the chat server 30 and file server 40 toward the client terminals 21, 22, . . . and visually recognized at the client terminals 21, 22, . . . is converted to image data in the image converter 10C; text data capable of revision, etc., is not transmitted to the client terminals 21, 22, . . . . The details of processing executed by the chat relay system 10 and the chat relay server 10A, chat control unit 10B and image converter 10C constituting the chat relay system 10 will be described later.

The chat relay server 10A, chat control unit 10B and image converter 10C constituting the chat relay system 10 may be independent devices, or the chat relay system 10 may be an independent system and the chat relay server 10A, chat control unit 10B and image converter 10C can be positioned as multiple functions implemented by multiple programs in the chat relay system 10.

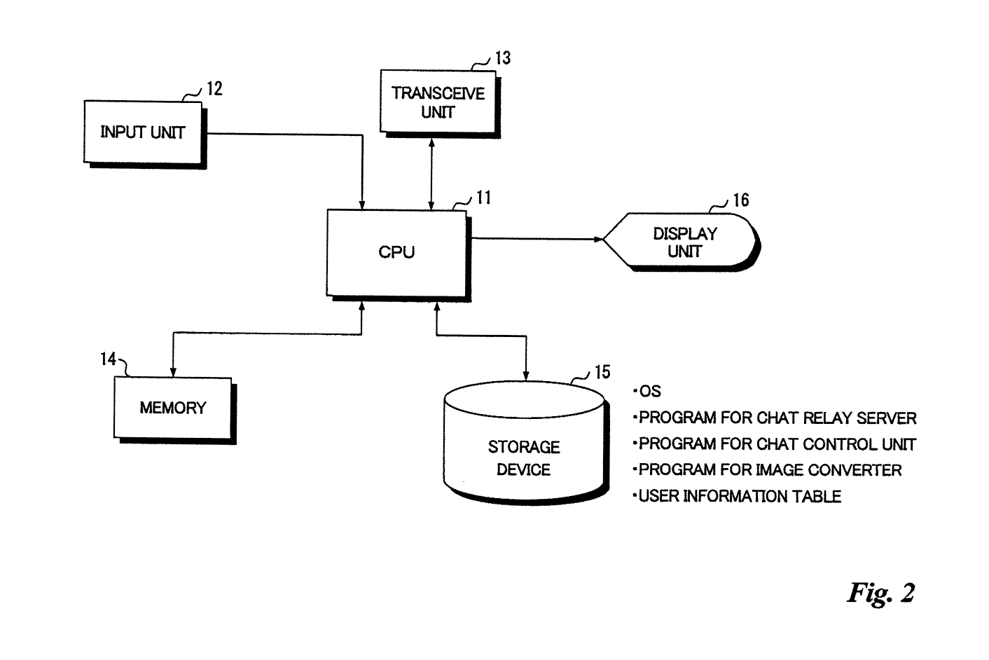

FIG. 2 is a block diagram illustrating the hardware configuration of the chat relay system 10. This block diagram illustrates a case where chat relay system 10 is an independent system and the chat relay server 10A, chat control unit 10B and image converter 10C are implemented as multiple functions by multiple programs in the chat relay system 10.

The chat relay system 10 has a CPU 11 for executing overall control of the chat relay system 10. Connected to the CPU 11 are an input unit (keyboard and mouse, etc.) 12 used in various character inputs, instructions and selections, etc., a transceive unit 13 for sending and receiving data to and from other computer systems and the like through a network (the Internet), a memory 14 for providing a work area and a buffer area, etc., a storage device 15 storing an operating system, various programs and data, and a display unit 16 for displaying characters and images, etc.

Also stored in the storage device 15 along with the operating system are a program for the chat relay server, a program for the chat control unit and a program for the image converter. The chat relay system 10 functions as the chat relay server 10A as a result of reading in and executing the chat relay server program in the CPU 11. Similarly, by executing the chat control unit program and image converter program in the CPU 11, the chat relay system 10 will function as the chat control unit 10B and image converter 10C, respectively. Naturally, as a result of the CPU 11 running multiple programs simultaneously, the chat relay system 10 will function as the chat relay server 10A, chat control unit 10B and image converter 10C simultaneously.

Basically, the client terminals 21, 22, . . . , chat server 30 and file server 40 also are computer systems having a hardware configuration similar to that of the chat relay system 10, namely a CPU, an input unit, a memory, a transceive unit, a storage device and a display unit, and by executing the programs that have been stored in these storage devices (a program for causing the terminal to function as a client of the chat system, a chat server program for causing the computer system to function as a chat server and a file server program for causing the computer system to function as a file server), the terminals or computer systems are embodied as the client terminals 21, 22, . . . , chat server 30 and file server 40 that make up the at system.

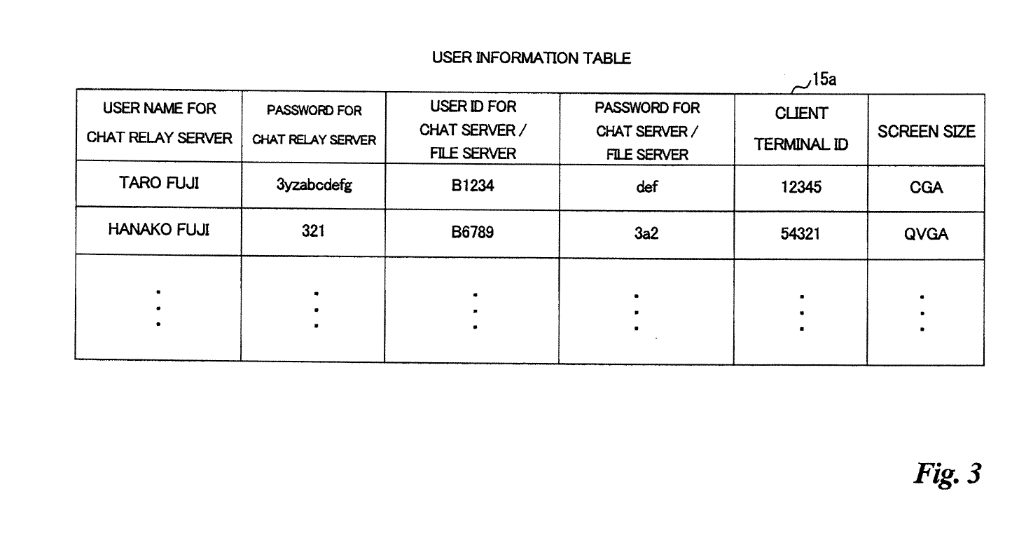

A user information table 15a has been stored in the storage device 15 of chat relay system 10. FIG. 3 illustrates the user information table 15a that has been stored in the storage device 15 of chat relay system 10.

Stored in the user information table 15a is information relating to users (chat users) who can chat using the client terminals 21, 22, . . . , i.e., who can visit (participate in) a chat room generated in the chat server 30. The user information table 15a includes, for each chat user, a user ID for the chat relay server, a password for the chat relay server, a user ID for the chat server/file server, and a password for the chat server/file server. The user ID for the chat server/file server and the password for the chat server/file server may be stored in a form in which the user ID for the chat server and password for the chat server are distinguished from the user ID for the file server and password for the file server. The details of these items will be described later. The user information table 15a further includes client terminal IDs and screen sizes. As will be described later, chat messages, etc., are transmitted to the client terminals 21, 22, . . . by image data. The size of this image data can be created in accordance with screen size specified by the client terminal ID.

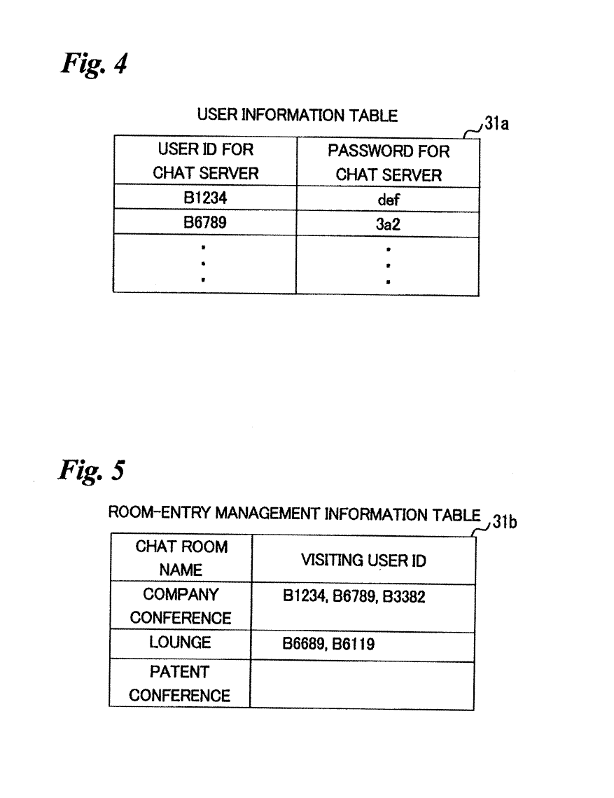

FIG. 4 illustrates a user information table 31a that has been stored in the storage device possessed by the chat server 30. An ID for the chat server and a password for the chat server have been stored with regard to each chat user in the storage device of the chat server 30.

FIG. 5 illustrates a room entry management information table 31b constructed (generated) in the storage device or in a memory of the chat server 30.

The chat server 30 provides a chat user with multiple chat rooms. Specifically, the chat user is capable of visiting (participating in) any chat room among these multiple chat rooms. Further, if multiple chat users are visiting a certain chat room, the same message is transmitted to these multiple chat users substantially simultaneously. Stored in the room entry management information table 31b are the names of current chat rooms and visiting user IDs specifying the chat users currently visiting (participating in) the respective chat rooms.

Although the details will be described later, a chat user is capable creating a chat room in simple fashion. When a chat room is created anew, a record containing the name of the newly created chat room (the chat room name) is added to the room entry management information table 31b anew. When a chat user visits (participates in) a chat room anew, the user ID of this chat user (the above-mentioned user ID for the chat server) is added anew to the visiting user ID column regarding the chat room visited. When the chat room is exited (when participation is cancelled), the user ID of this chat user is erased from the visiting user ID column.

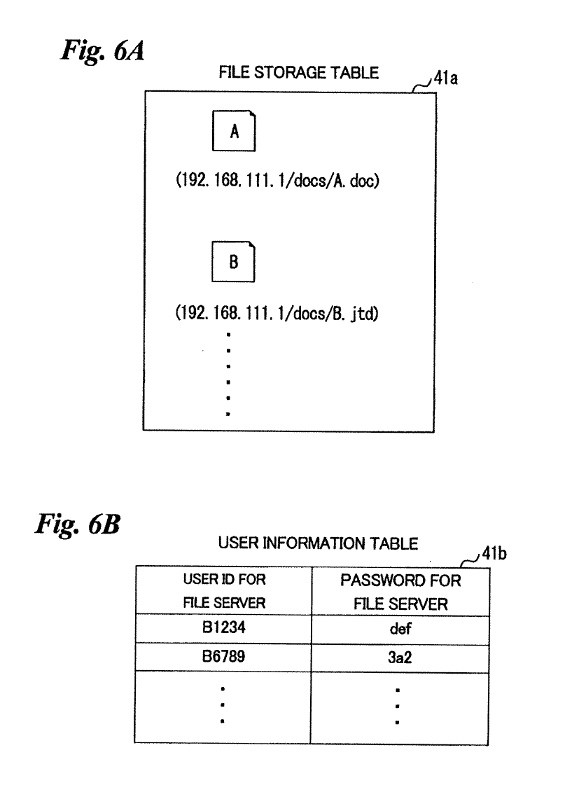

FIGS. 6A and 6B illustrate a file storage table 41a and user information table 41b, respectively, stored in the storage device of the file server 40.

As mentioned above, the chat system makes it possible for messages to be exchanged among multiple chat users and for documents represented by document files to be viewed, etc. Document files and the like viewable by a chat user have been stored in the file storage table 41a of file server 40.

Stored in the file storage table 41a along with the document files are the addresses (paths) of these document files. In a case where a document represented by a document file is viewed by a chat user, the address (path) of the document file is transmitted (provided) to the chat user as link information. By transmitting a view request from the client terminal of the chat user in accordance with the address of the document file, the document file (more specifically, image data obtained by converting the document file to an image) is transmitted to the client terminal and the content of the document is rendered visible (the details will be described later).

Stored in the user information table 41b with regard to each chat user are the ID for the file server and the password for the file server. The ID for the file server and the password for the file server may be the same as or different from the ID for the chat server and the password for the chat server.

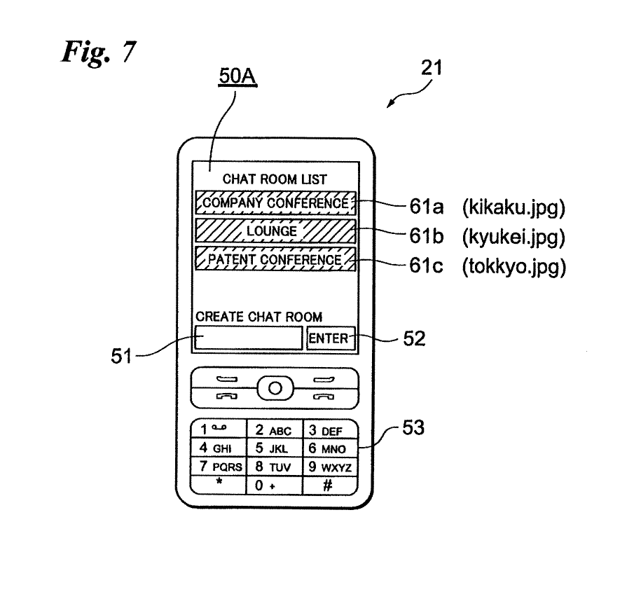

FIG. 7 illustrates the external appearance of the client terminal 21.

As mentioned above, the client terminal 21 has a CPU, an input unit, a memory, a transceive unit, a storage device and a display unit and becomes a client terminal in the chat system as a result of the CPU executing a program (referred to as a “chat program” below), which has been stored in the storage device, for causing the terminal to function as the client of the chat system.

The client terminal 21 has the display screen of its display unit situated in a large area near the upper side as seen from the front. The lower side is provided with an ENTER button 52 and a numeric keypad 53, etc.

A plurality of types of chat screens are displayed on the display screen of client terminal 21 by execution of the chat program. FIG. 7 illustrates a state in which the display screen is displaying a chat room list screen 50A, which is one of the chat screens.

The display screen of the client terminal 21, inclusive of the chat room list screen 50A, can be classified into an area (zone) in which a display is presented by the chat program, and an area (zone) displayed by image data transmitted from the chat relay system 10. In FIG. 7, characters reading “COMPANY CONFERENCE”, “LOUNGE” and “PATENT CONFERENCE” and rectangular zones 61a, 61b, 61c enclosing these characters are areas displayed by image data (kikaku.jpg, kyukei.jpg, tokkyo.jpg, respectively) transmitted from the chat relay system 10. The areas displayed on the chat screen by the image data transmitted from the chat relay system 10 are highlighted by hatching.

Besides the characters reading “COMPANY CONFERENCE”, “LOUNGE” and “PATENT CONFERENCE” and the rectangular zones 61a, 61b, 61c enclosing these characters, there is an area (zone) in which a display is presented by the chat program. Specifically, characters reading “CHAT ROOM LIST”, characters reading “CREATE CHAT ROOM”, a character entry box 51 (an area in which characters can be entered using the numeric keypad) and the ENTER button 52 (here this is an area clicked when a new chat room having the name entered in the character entry box 51 is created) are displayed by the chat program.

Processing executed by the client terminal, chat relay system, chat server and file server, which constitutes the various kinds of processing of the chat system, will be described below. The processing executed by the chat system is divided into seven types of processing, namely (1) log-in processing, (2) chat room creation processing, (3) chat room entry processing, (4) processing for creating, transmitting and receiving messages, (5) view file selection processing, (6) file view processing and (7) processing for changing the display on the client terminal. The processing executed by the client terminal, chat relay system, chat server and file server in each of these seven types of processing will be described below. Further, in the description that follows, the client terminals 21 and 22 will be used as the client terminals in the description in order to facilitate comprehension. It goes without saying that many client terminals in the chat system are capable of participating in a chat simultaneously.

(1) Log-In Processing

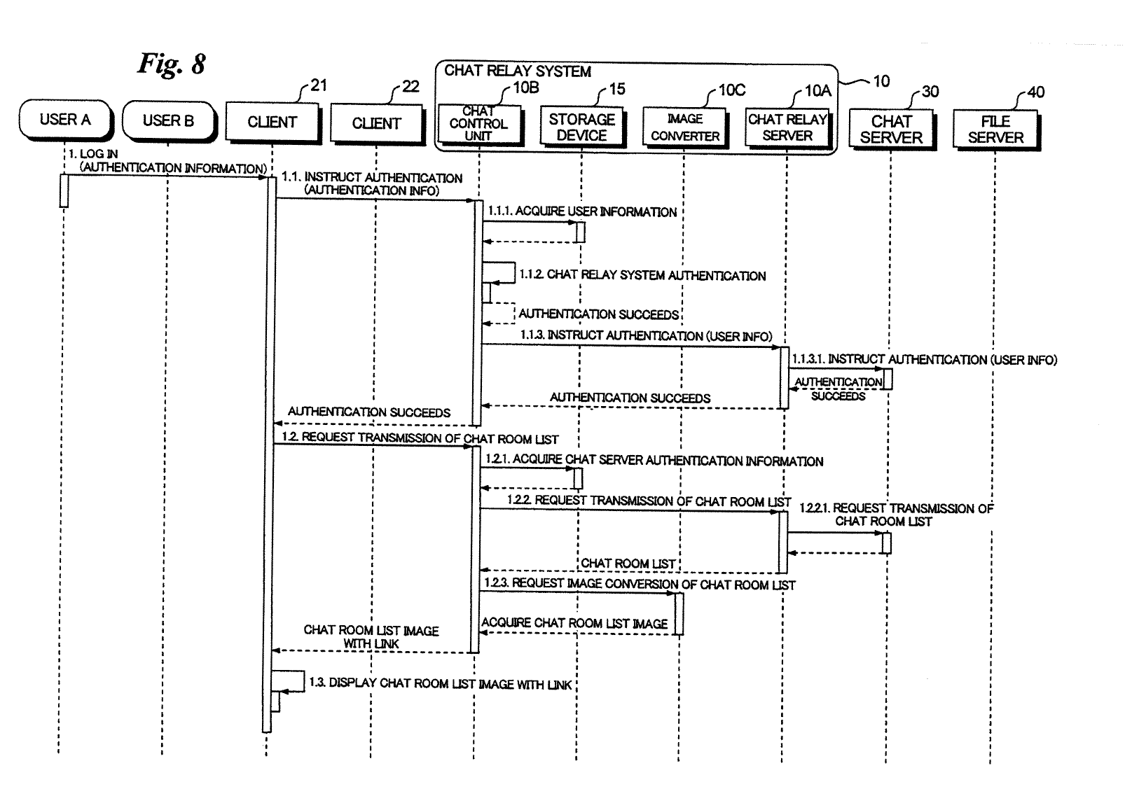

FIGS. 8, 9 and 10 are sequence diagrams illustrating processing executed by the client terminals, chat relay system, chat server and file server in log-in processing. FIGS. 11 and 12 illustrate examples of screens displayed on the display unit of client terminal 21 in log-in processing.

Processing executed when log-in succeeds is shown in FIG. 8.

When a chat is started, the chat program is launched by the owner (assumed to be user A) of client terminal 21, whereupon a log-in information input screen 50C appears on the display screen of client terminal 21. The log-in information input screen 50C is illustrated in FIG. 11.

The log-in information input screen 50C includes a user name input field 54, a password input field 55, the ENTER button 52 and a cancel button 56. The user name is entered in the user name input field 54 and a password is entered in the password input field 55 (step 1 in FIG. 8). A user name and password that have been given to the chat user in advance by the administrator of the chat system or a user name and password that have been designated are used as the user name and password.

When the ENTER button 52 is clicked, the set composed of the entered user name and password (namely authentication information) is transmitted to the chat relay system 10 via the network (step 1.1 in FIG. 8). The IP address, MAC address and terminal ID, etc., that have been assigned to the client terminal 21 and data for specifying the client terminal 21 on the network are transmitted to the chat relay system 10. When the cancel button 56 is clicked, the already entered character strings are erased from the user name input field 54 and password input field 55.

When the set composed of the user name and password is received by the chat relay system 10, authentication processing is executed in the chat control unit 10B (steps 1.1, 1.1.1, 1.1.2 in FIG. 8). In the authentication processing, it is determined whether the user name and password in the received set have been stored in “USER NAME FOR CHAT RELAY SERVER” and “PASSWORD FOR CHAT RELAY SERVER” in the user information table 15a (FIG. 3) stored in the storage device 15.

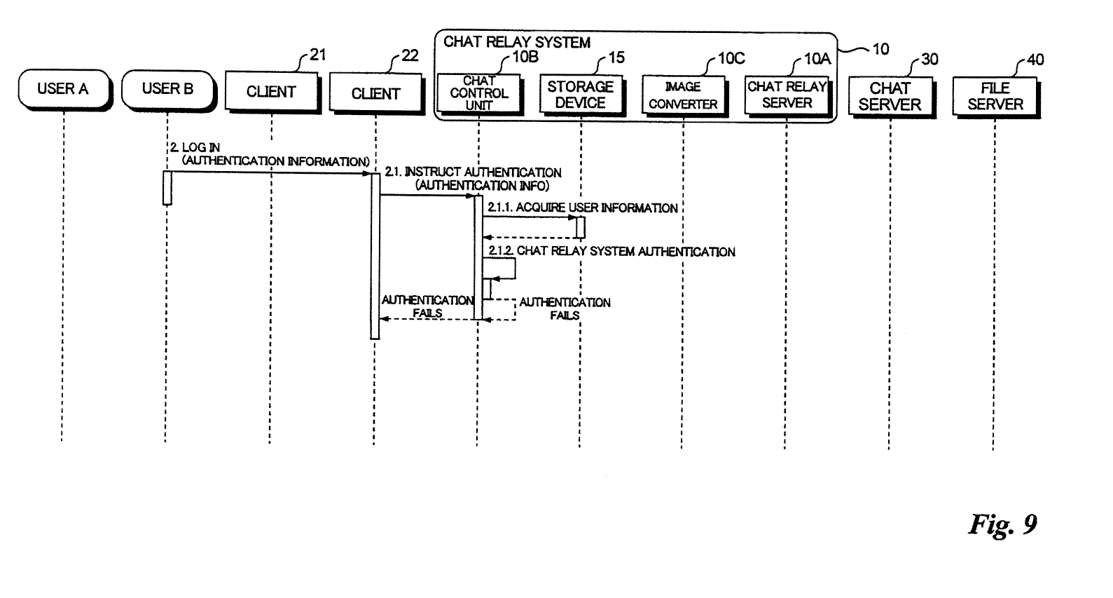

FIG. 9 illustrates the processing executed when the user name and password in the received set have not been stored in “USER NAME FOR CHAT RELAY SERVER” and “PASSWORD FOR CHAT RELAY SERVER” in the user information table 15a. With reference to FIG. 9, an authentication failure decision is rendered in the chat control unit 10B and this result is transmitted to the client terminal 22 if a user name and password in a set input at the client terminal 22 owned by user B have not been stored in “USER NAME FOR CHAT RELAY SERVER” and “PASSWORD FOR CHAT RELAY SERVER” in the user information table 15a (steps 2, 2.1, 2.1.1, 2.1.2 in FIG. 9). Words such as “USER NAME OR PASSWORD IS INCORRECT” notifying the user of authentication failure is displayed in place of the log-in information input screen 50C on the display screen of the client terminal 22.

Returning to FIG. 8, if authentication succeeds in the chat control unit 103, i.e., if the user name and password in the received set have been stored in “USER NAME FOR CHAT RELAY SERVER” and “PASSWORD FOR CHAT RELAY SERVER” of user information table 15a, then the chat control unit 103 reads a set composed of “USER ID FOR CHAT SERVER/FILE SERVER” and “PASSWORD FOR CHAT SERVER/FILE SERVER” corresponding to the authenticated user name and password out of user information table 15a and transfers the set to the chat relay server 10A. The chat relay server 10A transmits the set of this user ID and password to the chat server 30 via the network (step 1.1.3 in FIG. 8).

What has been stored in the user information table 31a stored in the storage device of chat server 30 is not the “USER NAME FOR CHAT RELAY SERVER” and “PASSWORD FOR CHAT RELAY SERVER” entered by the user but the corresponding “USER ID FOR CHAT SERVER” and “PASSWORD FOR CHAT SERVER” (FIG. 4). The chat server 30 determines whether the set composed of the received user ID and password has been stored in the user information table 31a (step 1.1.3.1 in FIG. 8).

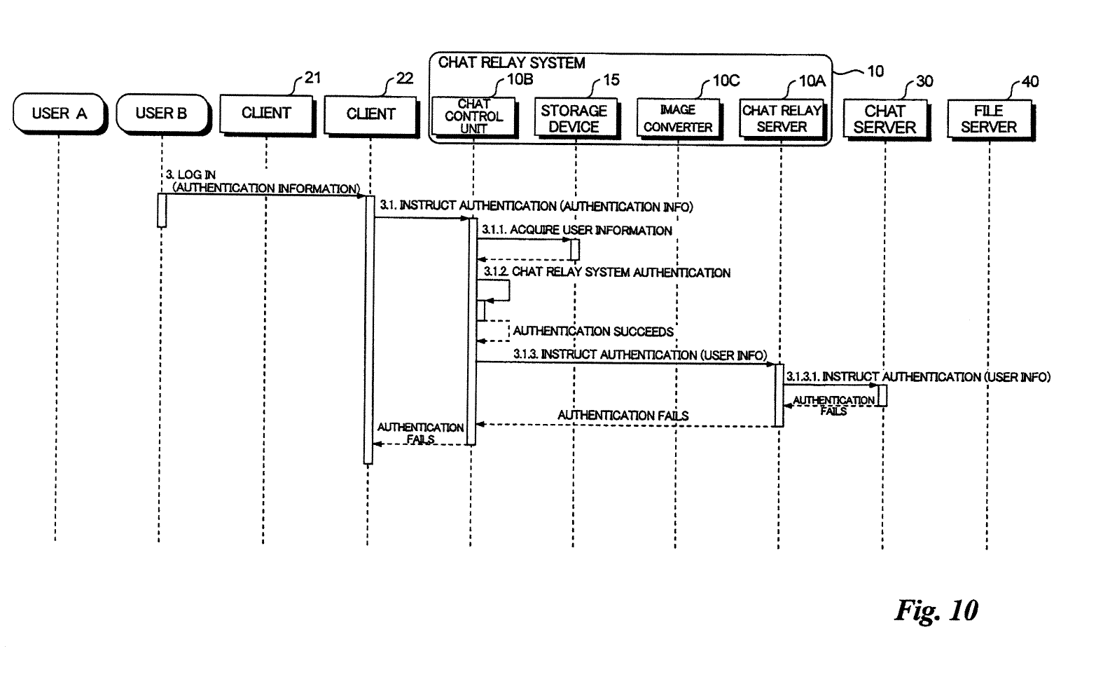

FIG. 10 illustrates the processing executed when the set composed of the received user ID and password has not been stored in the user information table 31a of chat server 30. With reference to FIG. 10, in this case the chat server 30 renders a decision (authentication failure) to the effect that authentication could not be achieved and transmits this result to the client terminal 21. Words such as “USER NAME OR PASSWORD IS INCORRECT” notifying the user of authentication failure are displayed in place of the log-in information input screen 50C on the display screen of the client terminal 21 (steps 3, 3.1, 3.1.1, 3.1.2, 3.1.3, 3.1.3.1 in FIG. 10).

Returning to FIG. 8, if authentication processing succeeds also in the chat server 30 (step 1.1.3.1 in FIG. 8), then a message to the effect that authentication has succeeded is transmitted from the chat server 30 to the chat relay server 10A of chat relay system 10 via the network, and the chat relay server 10A transfers this message to the chat control unit 10B. The chat control unit 10B transmits the message indicative of authentication success to the client terminal 21 via the network.

Upon receiving the message indicative of authentication success, the client terminal 21 transmits a message, which requests transmission of a list of chat rooms, to the chat relay system 10 together with the user name (step 1.2 in FIG. 8). The user name transmitted to the chat relay system 10 along with the message requesting transmission of a list of chat rooms makes use of that entered at the time of log-in.

At the chat relay system 10 that received the message requesting transmission of a list of chat rooms and the user name, the user name (the user name for the chat relay server) is replaced by the corresponding user ID (the user ID for the chat server/file server) by the chat control unit 10B using the user information table 15a (FIG. 3) (step 1.2.1 in FIG. 8) (acquisition of chat server authentication information). The message requesting transmission of a list of chat rooms and the user ID are transferred from the chat control unit 10B to the chat relay server 10A. The message requesting transmission of a list of chat rooms and the user ID are transmitted to the chat server 30 via the network (step 1.2.2 in FIG. 8).

Upon receiving the message requesting transmission of a list of chat rooms, the chat server 30 reads out the chat room names that have been stored in the room entry management information table 31b (FIG. 5) stored in the storage device of the chat server 30 and creates an HTML file containing text data representing all of the chat room names and link data (request data) for visiting (participating in) the chat rooms.

In the case of an ordinary chat system, an HTML file for displaying a list of chat rooms and containing text data representing chat room names and link data for requesting entry to the chat rooms is transmitted to the client terminal 21, where the chat room names of chat rooms in which participation is possible are displayed on the screen in accordance with the text data representing chat room names. For example, in a case where the three chat rooms “COMPANY CONFERENCE”, “LOUNGE” and “PATENT CONFERENCE” have been stored in the room entry management information table 31b (FIG. 5), an HTML file for displaying the list of chat rooms and that includes the text data representing these chat room names as well as the link data associated with these items of text data [the link data is data representing a request to enter each of the chat rooms (this data is also text data)] is transmitted from the chat server 30 to the client terminal 21.

However, with the chat system of this embodiment, as will be described next, the data transmitted from the chat server 30 (and the file server 40 described later) to the client terminals 21, 22 is converted, with the exception of the link data, to an image and is then transmitted to the client terminals 21, 22 as image data.

The HTML file for displaying the list of chat rooms containing the text data representing the chat room names and the link data for requesting entry to the chat rooms is transmitted to the chat relay system 10 and not to the client terminal 21 that transmitted the message requesting transmission of a list of chat rooms (step 1.2.2.1 in FIG. 8). The chat relay server 10A then transfers the HTML file for displaying the list of chat rooms to the chat control unit 10B, and the latter further transfers this HTML file to the image converter 10C. The image converter 10C converts the text data representing the chat room names described in the received HTML file to image data (e.g., jpg data) and creates image files containing this image data and the link data (convert chat room list to images) (step 1.2.3 in FIG. 8). For example, when HTML data regarding the three chat room names “COMPANY CONFERENCE”, “LOUNGE” and “PATENT CONFERENCE” is sent to the image converter 10C, the latter creates three image files in correspondence with these chat room names.

The created image files are transferred from the image converter 10C to the chat control unit 10B and thence to the client terminal 21 via the network.

The client terminal 21 (chat program) creates a display screen that includes icons (icon images) represented by the image data contained in the received image files. In a case where link data is contained in an image file, the icon image is displayed in clickable form. When the icon image is clicked, processing (for request transmission, etc.) in accordance with the link data is executed. An image file transmitted to the client terminal 21 may be accompanied by the type of chat screen to be used by this image file (for example, the screen type is that of an image file to be used in creating the chat room list screen 50A).

FIG. 12 is an example of the chat room list screen 50A which, in this case, includes three icons 61a, 61b, 61c with links. The display areas (namely the icons 61a, 61b, 61c) based upon the data that has been transmitted from the chat server 30 are hatched. As mentioned earlier, however, this is only for the purpose of making it easier to understand that these are display areas based upon data that has been transmitted from the chat server 30 and that they are images based upon image data (and not character displays based upon text data). It goes without saying that hatching does not appear on the actual chat room list screen 50A.

In a case where the image files created in the image converter 10C contain (are accompanied by) link data, the icons 61a, 61b, 61c are displayed in clickable form on the display screen as mentioned above. When the icons 61a, 61b, 61c with the accompanying links are clicked, processing in accordance with the descriptions in the link data (examples are processing for transmitting a message requesting entry to a specific chat room, processing for requesting transmission of a list of files that have been stored in the file server 40, etc.) is executed by the client terminal 21 (step 1.3 in FIG. 8) (the details will be described later).

(2) Chat Room Creation Processing

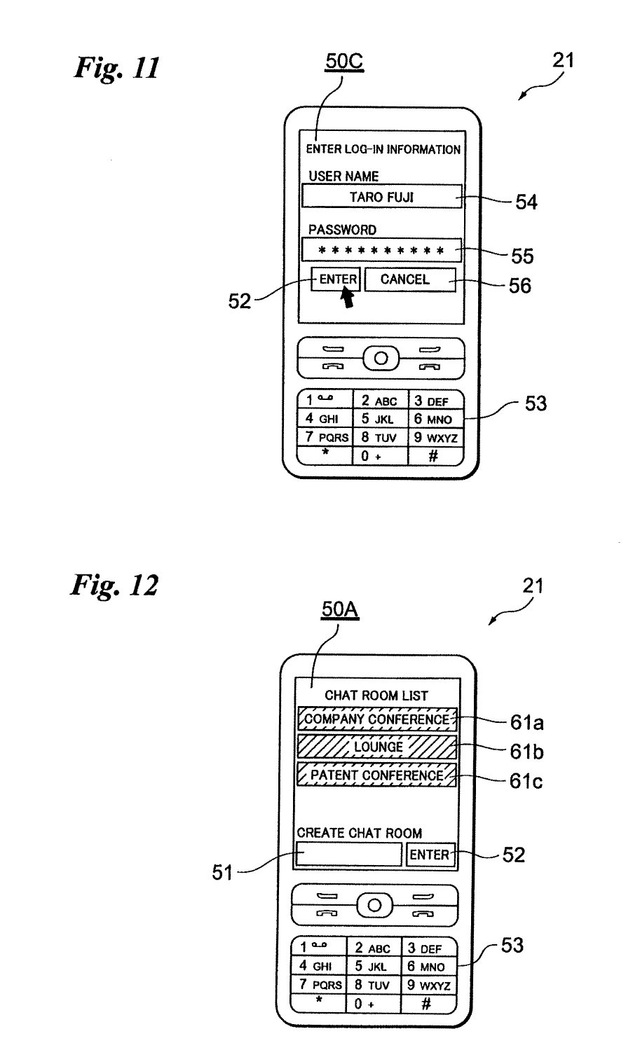

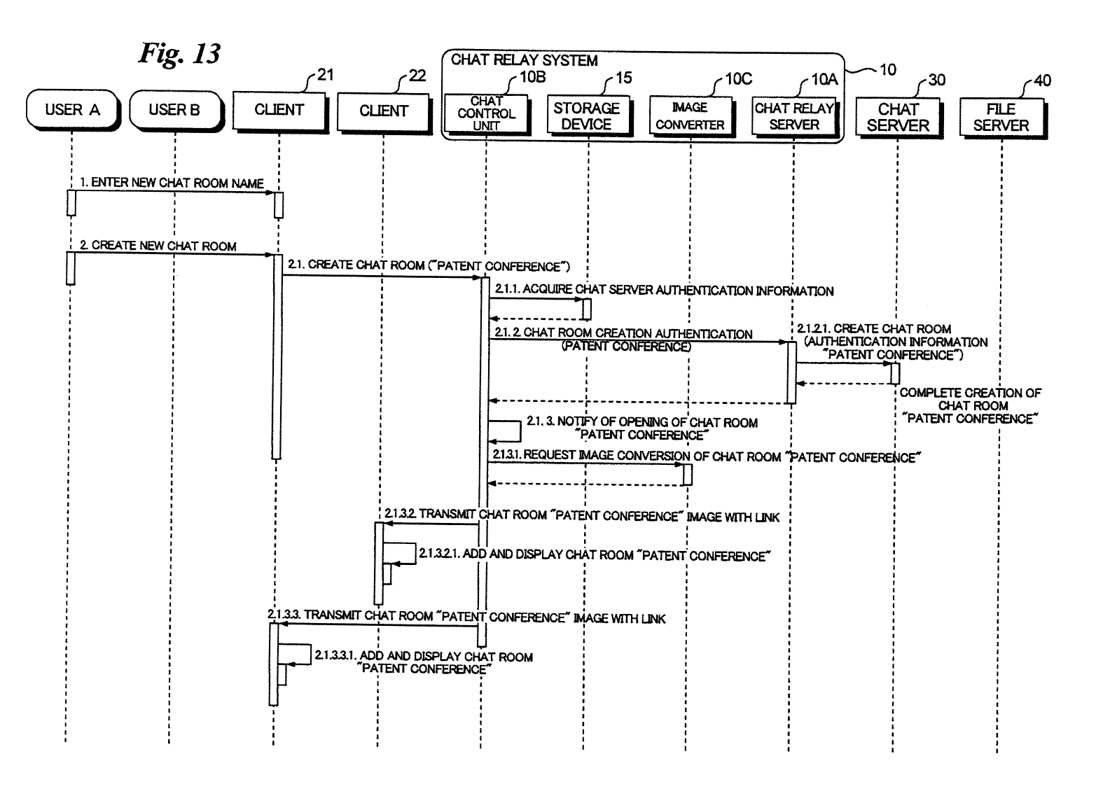

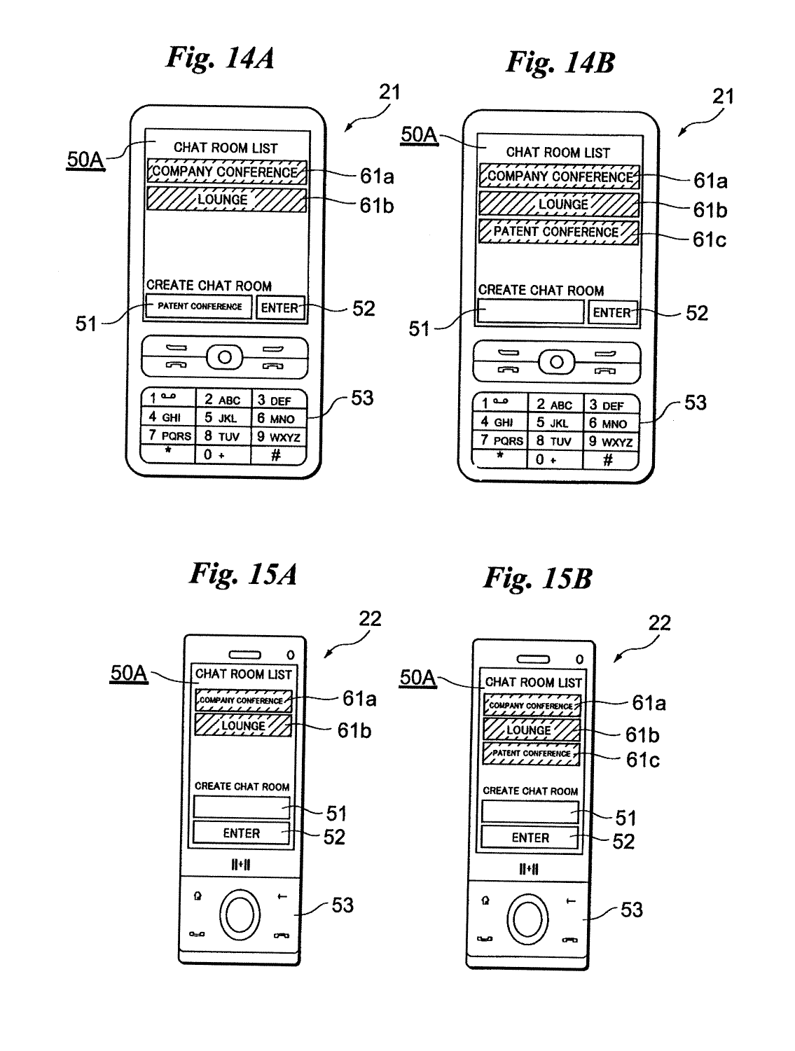

FIG. 13 is a sequence diagram illustrating processing executed by the client terminals, chat relay system, chat server and file server in processing for creating a chat room. FIGS. 14A and 14B and FIGS. 15A and 15B illustrate examples of screen displays presented on the display units of the client terminals 21, 22 in processing for chat room creation.

Assume that two chat rooms having the chat room names “COMPANY CONFERENCE” and “LOUNGE” have been stored in the room entry management information table 31b (FIG. 5) stored in the storage device of chat server 30. In this case, the chat room list screen 50A (FIG. 14A) of client terminal 21 is formed using two items of image data representing the characters “COMPANY CONFERENCE” and “LOUNGE” and the rectangular areas 61a, 61b. Even if the client terminal 22 possessed by the other chat user B is used, the chat room list screen 50A (FIG. 15A) is formed using the two items of image data representing the characters “COMPANY CONFERENCE” and “LOUNGE” and the rectangular areas 61a, 61b in a similar manner.

In a case where a chat room is created anew, the name of the chat room to be created anew is entered in the character entry box 51 located immediately below the character string “CREATE CHAT ROOM”, and then the ENTER button 52 located alongside the character entry box 51 is clicked. A message requesting chat room creation, text data representing the chat room name and the user name are transmitted from the client terminal 21 to the chat relay system 10 via the network (steps 1, 2, 2.1 in FIG. 13).

The message requesting chat room creation, the text data representing the chat room name and the user ID corresponding to the user name are transferred to the chat relay server 10A by the chat control unit 10B and then are transmitted to the chat server 30 via the network (steps 2.1.1, 2.1.2 in FIG. 13). The chat server 30 creates a new record in the room entry management information table 31b and stores the received chat room name in the chat room name section. As a result, a new chat room is created (step 2.1.2.1 in FIG. 13).

When creation of the chat room ends, the chat server 30 creates an HTML file, which contains text data representing the created chat room name and link data for requesting entry to this chat room, and transmits this HTML file to the chat relay system 10. The created HTML file is transferred from the chat relay server 10A to the chat control unit 10B to notify it of opening of a new chat room, after which it is transferred to the image converter 10C. Here, in a manner similar to that described above, an image file containing the link data and the image data is created (steps 2.1.3, 2.1.3.1 in FIG. 13). When the image file is transmitted to the client terminal 21, the client terminal 21 creates and displays a new chat room list screen 50A, which in this case includes an image icon represented by the image data contained in the received image file. Thus an update is applied to the chat room list screen 50A containing the added chat room name (steps 2.1.3.3, 2.1.3.3.1 in FIG. 13) (see FIG. 14B).

The above-mentioned image file is transmitted also to the client terminal 22 being used by the other chat user B who has logged into the chat system. The client terminal 22 also has its screen updated to the chat room list screen 50A containing the added chat room name (steps 2.1.3.2, 2.1.3.2.1 in FIG. 13) (see FIG. 15B).

(3) Chat Room Entry Processing

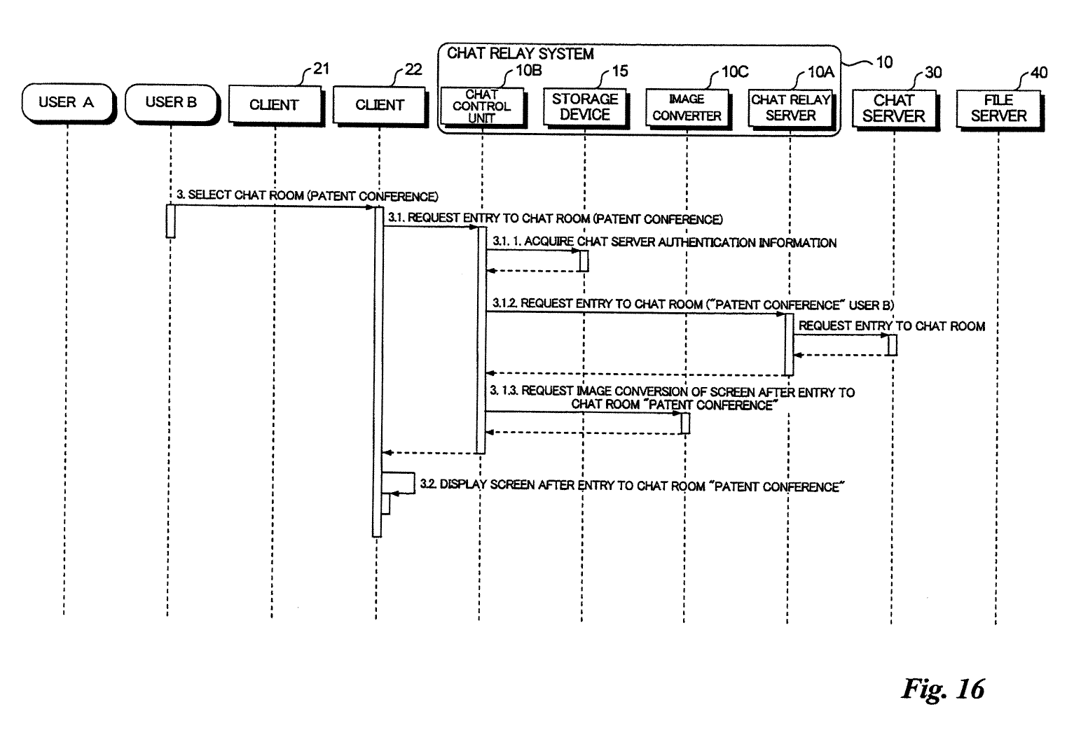

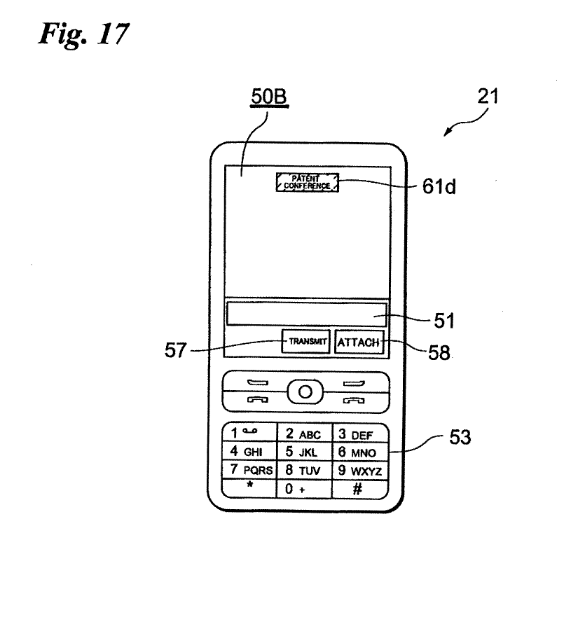

In a chat system, chat system log-in and subsequently executed chat room entry (participation) processing are differentiated from each other. As a result of logging into the chat system and then subsequently executing processing for entering a chat room, messages (text and the like) are exchanged with other chat users who are visiting the same chat room. FIG. 16 is a sequence diagram illustrating processing for entering a chat room. FIG. 17 illustrates an example of a screen displayed on the client terminal 21 when entry to the chat room “PATENT CONFERENCE” has been completed.

The names of chat rooms being managed by the chat server 30 at the present time are displayed on the chat room list screen 50A (see FIGS. 14B and 15B) by the icon images 61a, 61b, 61c. As mentioned above, the icon images 61a, 61b, 61c of the chat room names are accompanied by respective links and, when the icon images 61a, 61b, 61c are clicked, processing in accordance with the link data is executed in the client terminals 21, 22.

The link data accompanying the icon images 61a, 61b, 61c of the chat room names on the chat room list screen 50A is data representing a request for chat room entry (participation). For example, if any of the icon images 61a, 61b, 61c is clicked by user B, a chat room entry request message containing the chat room name corresponding to the clicked icon image 61a, 61b or 61c and the user name are transmitted from the client terminal 22 to the chat relay system 10 (steps 3, 3.1 in FIG. 16).

The chat control unit 10B transfers the chat room entry request message and the user ID corresponding to the user name to the chat relay server 10A (steps 3.1.1, 3.1.2 in FIG. 16). The chat room entry request message and user ID are transmitted from the chat relay server 10A to the chat server 30 via the network.

Upon receiving the chat room entry request message, the chat server 30 stores the user ID anew in the room entry management information table 31b in the record corresponding to the chat room name in the chat room entry request message. This completes the processing for allowing the chat user B to enter the specific chat room.

The chat server 30 creates an HTML file containing text data representing the chat room name for which entry processing has been executed and transmits the HTML file to the chat relay server 10A. The HTML file is sent to the image converter 10C via the chat control unit 10B. The image converter 10C converts to image data the text data representing the chat room name for which entry processing has been executed. The image file containing the image data is transmitted to the client terminal 22 via the chat control unit 10B (step 3.1.3 in FIG. 16).

The client terminal 22 (chat program) creates a display screen that includes the image (image icon) represented by the image data contained in the received image file. FIG. 17 illustrates an example of a basic chat screen 50B regarding the chat room “PATENT CONFERENCE”. As mentioned above, the image file transmitted to the client terminal contains data specifying the type of chat screen to be used by this image file. If the type of screen is the basic chat screen 50B, then the client terminal (chat program) creates and displays the basic chat screen 50B that includes the image (icon image) represented by the image data contained in the received image file. A character portion 61d reading “PATENT CONFERENCE” is represented by image data (jpg data, etc.) obtained by converting the text data to image data in the image converter 10C (step 3.2 in FIG. 16).

The image file transmitted from the chat relay system 10 to the client terminal in chat room entry processing is not accompanied by link data. Therefore, unlike the images 61a, 61b, 61c on the above-mentioned chat room list screen 50A (FIG. 14B), the “PATENT CONFERENCE” area on the basic chat screen basic chat screen 50B (FIG. 17) cannot be clicked.

The basic chat screen 50B includes the chat room name (“PATENT CONFERENCE”) 61d represented by the image data, the character entry box 51, a transmission button 57 and an attachment button 58. As will be described next, comments (input character strings), etc., of other chat users are displayed in the area between the chat room name image 61d and the character entry box 51.

(4) Processing for Creating, Transmitting and Receiving Messages

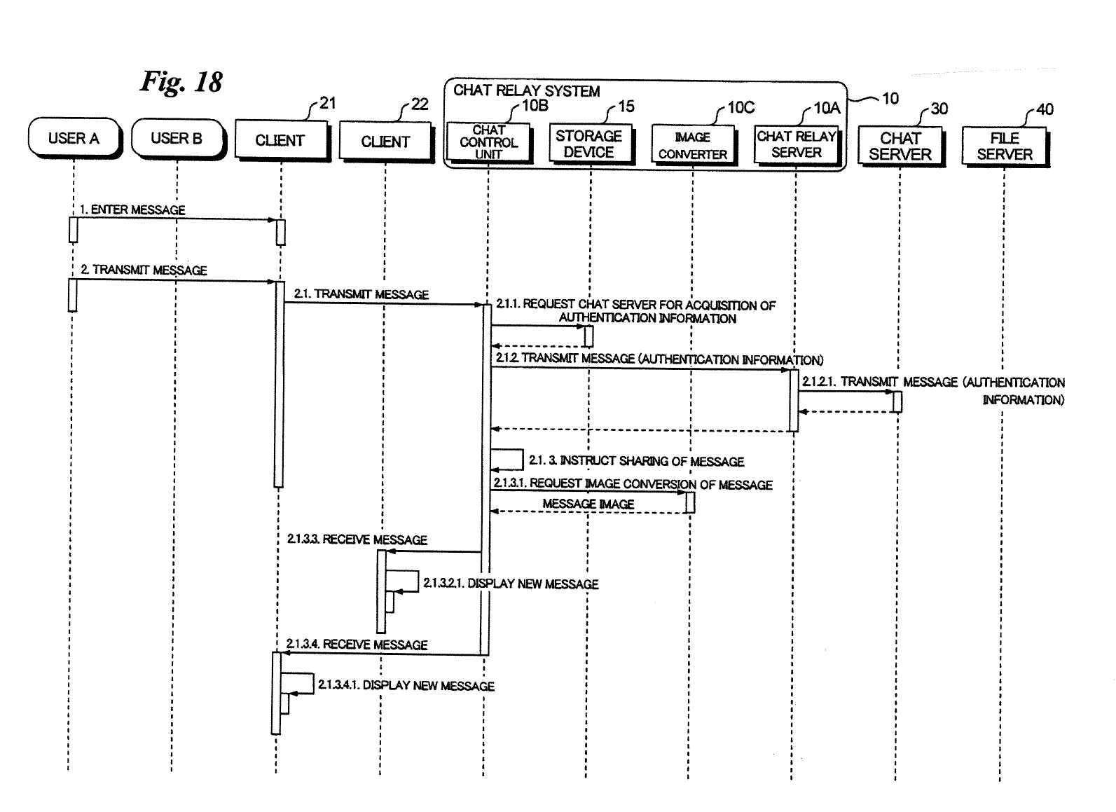

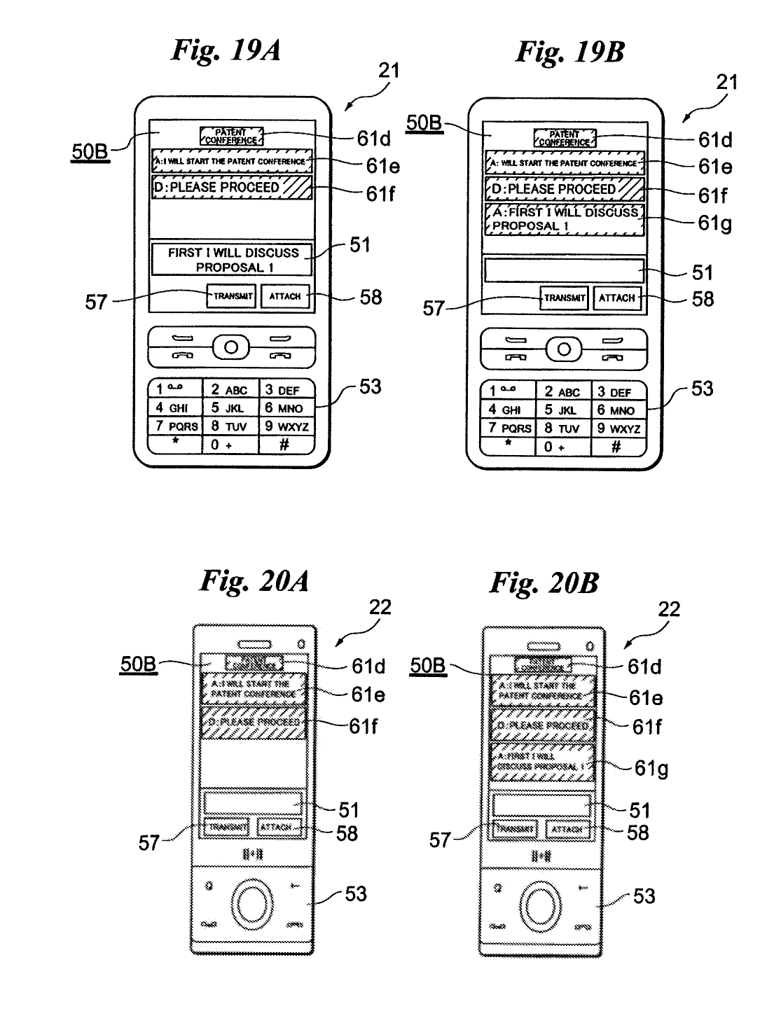

FIG. 18 is a sequence diagram illustrating processing executed by the client terminals, chat relay system, chat server and file server in processing for creating, transmitting and receiving messages. FIGS. 19A and 19B and FIGS. 20A and 20B illustrate examples of screen displays presented on the display units of the client terminals 21, 22 in processing for creating, transmitting and receiving messages. The description that follows centers on a case where user A enters a comment (inputs characters) using client terminal 21.

The comment (entered character string) of the chat user is displayed in a row in a time series on the basic chat screen 50B. This comment by the chat user is also converted to an image by the image converter 10C in the manner described above. That is, the chat user's comment is displayed by an image based upon image data and is not displayed as a comment based upon text data.

The basic chat screen 50B includes the character entry box 51, as mentioned above. The message (content of the comment) (a character string) that has been entered using the numeric keypad 53 is displayed in the character entry box 51 (step 1 in FIG. 18). It goes without saying that the character string displayed in the character entry box 51 is a character string represented by text data.

When the transmission button 57 is clicked, the text data (referred to as a “message” below) representing the character string entered in the character entry box 51 is transmitted to the chat relay system 10 together with the user name (steps 2, 2.1 in FIG. 18). The message is transmitted to the chat server 30 via the chat relay server 10A together with the user ID corresponding to the user name (steps 2.1.1, 2.1.2 in FIG. 18).

The chat server 30 creates an HTML file containing the received message and transmits the file to the client terminals 21, 22 of the chat users currently participating in the chat room (step 2.1.2.1 in FIG. 18). Since the data transmitted from the chat server 30 is transmitted to the chat relay system 10 and not directly to the client terminals 21, 22, as mentioned above, the HTML file containing the message also is transmitted to the chat relay system 10. instruction to the effect that the message is to be transmitted to the client terminals of all chat users currently participating in the chat also is transmitted from the chat server 30 to the chat control unit 10B (step 2.1.3 in FIG. 18). The HTML file containing the message is then transferred to the image converter 10C of chat relay system 10 together with an image conversion instruction (step 2.1.3.1 in FIG. 18).

The message is subjected to image conversion processing. When the image file containing the image data representing the message is transmitted to the client terminals 21, 22, a new message is displayed on the basic chat screen 50B of each of the client terminals 21, 22 based upon the image data (steps 2.1.3.3, 2.1.3.2.1, 2.1.3.4, 2.1.3.4.1 in FIG. 18).

With reference to FIG. 19A, comments (character strings entered by respective users A and D) already entered by user A (represented by “A:” on the basic chat screen 50B) and by user D (represented by “D:” on the basic chat screen 50B) are being displayed in FIG. 19A. On the basic chat screen 50B shown in FIG. 19A, “PATENT CONFERENCE” 61d, “A: I WILL START THE PATENT CONFERENCE” 61e and “D: PLEASE PROCEED” 61f are images based upon image data that has been created by the image converter 10C. The same basic chat screen 50B is displayed on client terminal 22 of user B as well at the same timing (FIG. 20A).

As mentioned above, when user A enters a new message in the character entry box 51 and clicks the transmission button 57, the entered message (text data) is transmitted to the chat server 30 via the chat relay system 10 and then is transmitted from the chat server 30 to the client terminals 21, 22. In the course of transmission of the message from the chat server 30 to the client terminals 21, 22, the message is converted to an image by the image converter 10C and the image obtained by the conversion (the message image) is displayed on the basic chat screen 50B as an additional message (61g in FIG. 19B). The message image 61g is displayed as an additional message also on the basic chat screen 50B of client terminal 22 of user B at the same timing (FIG. 20B).

(5) View File Selection Processing (Processing for Creating, Transmitting and Receiving Messages Containing View File Information)

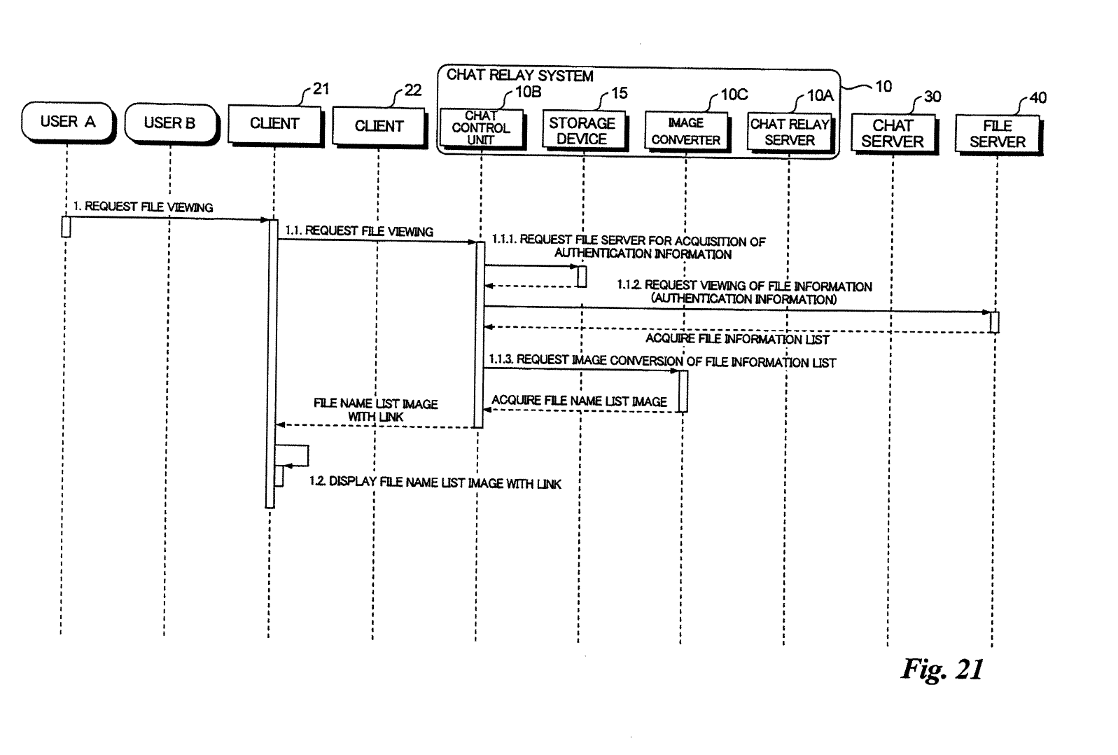

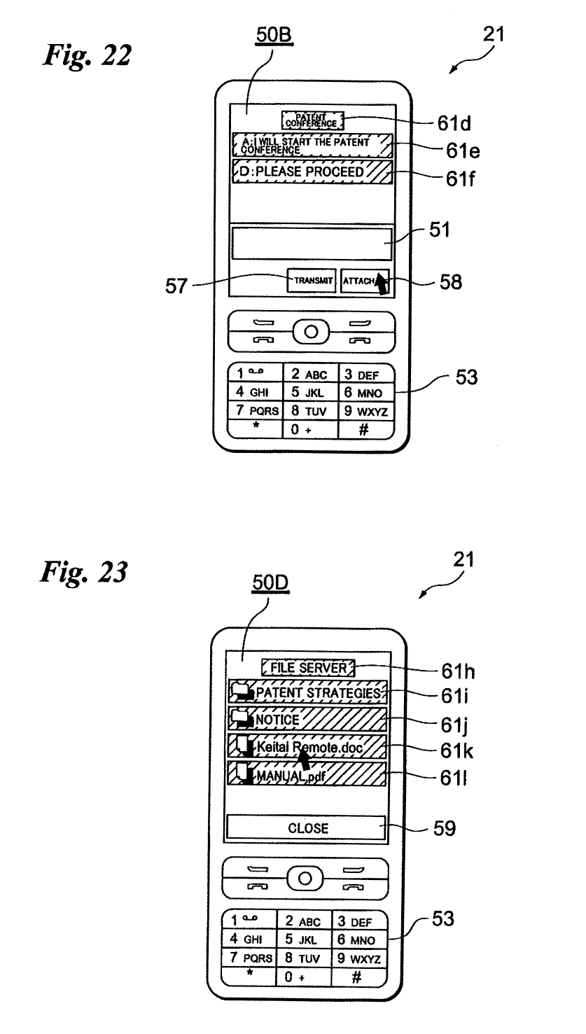

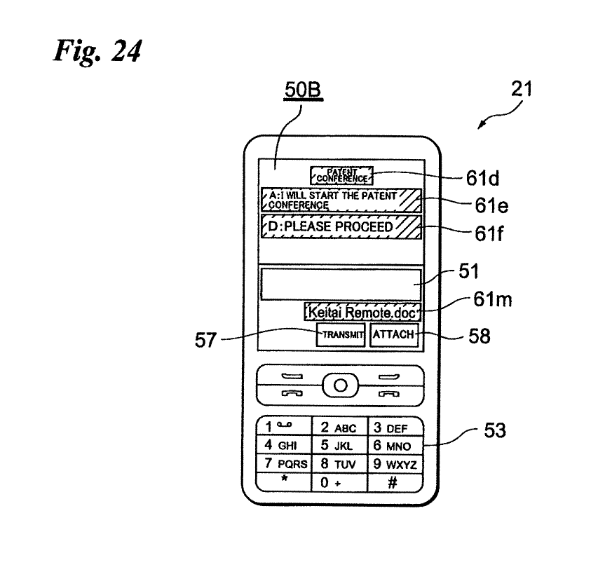

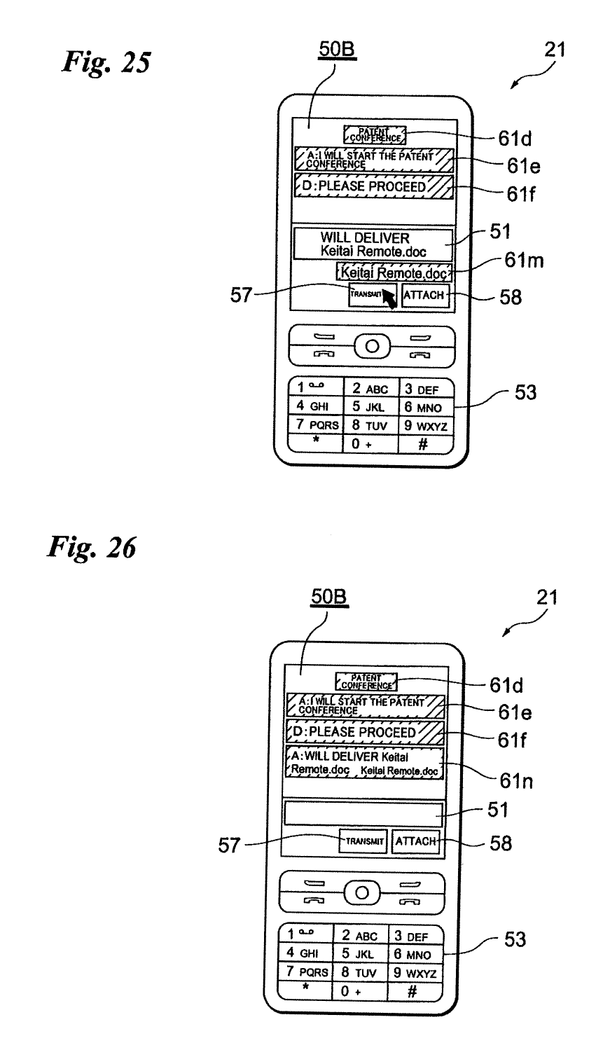

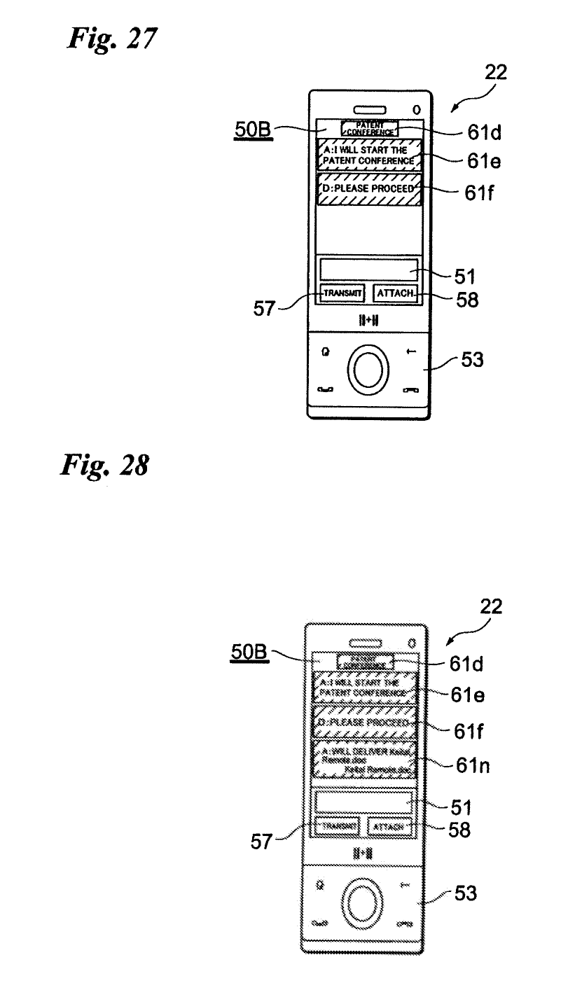

FIG. 21 is a sequence diagram illustrating processing executed by the client terminals, chat relay system, chat server and file server in processing for selecting a view file. FIGS. 22 and 23 illustrate examples of screens displayed on the display unit of client terminal 21 in processing for selecting a view file. FIGS. 24 and 25 illustrate examples of screens displayed on the display unit of client terminal 21 when a message containing information on a view file selected in view file selection processing is transmitted and received, and FIGS. 27 and 28 illustrate examples of screens displayed on the display units of the client terminal 22 at these times.

The file server 40 makes its appearance in processing for selecting a view file. As mentioned above, the file server 40 provides document files and the like capable of being viewed by the chat user, and the file storage table 41a (FIG. 6A) and user information table 41b (FIG. 6B) have been stored in the storage device thereof.

In a case where the content of a file that has been stored in the file server 40 is allowed to be viewed by a chat user participating in the chat room “PATENT CONFERENCE”, first the attachment button 58 on the basic chat screen 50B is clicked, as shown in FIG. 22. When the attachment button 58 is clicked, the user name, password and a file view request message are transmitted from the client terminal 21 and received by the chat relay system 10 (steps 1, 1.1, 1.1.1 in FIG. 21). The chat control unit 10B reads the user ID and password (the user ID for the chat server/file server and the password for the chat server/file server) corresponding to the received user name and password (the user name for the chat relay server and the password for the chat relay server) out of the user information table 15a (FIG. 3) and transmits the user ID and password that have been read out as well as the file view request message to the file server 40 (step 1.1.2 in FIG. 21).

The file server 40 determines whether the set composed of the received user ID and password has been stored in the user information table 41b (FIG. 6B) stored in the storage device. If the set has not been stored, a message representing authentication failure is sent back. This processing is the same as that executed by the chat server 30 described earlier.

If authentication succeeds, the file server 40 transmits the file names of document files that have been stored in the user information table 41b (FIG. 6A) and the directory names of directories (folders) with which a plurality of document files have been associated to the chat relay system 10 together with link data (paths to files and directories in file server 40). The file names, directory names and link data are all text data.

The chat control unit 10B transfers the received file names, directory names and link data to the image converter 10C, where image conversion is executed to convert the file names and directory names to image data. Image files containing the image data representing the file names and directory names obtained by the image conversion as well as the link data are transmitted to the client terminal 21 (steps 1.1.3, 1.2 in FIG. 21).

FIG. 23 shows a file server screen 50D displayed on the client terminal 21 in processing for selecting a view file. If the attachment button 58 on the basic chat screen 50B of FIG. 22 is clicked, the screen changes over to the file server screen 50D shown in FIG. 23. The file server screen 50D includes an image 61h representing characters reading “FILE SERVER”, an image 61i representing a directory-shaped picture and characters reading “PATENT STRATEGIES”, an image 61j representing a directory-shaped picture and characters reading “NOTICE”, an image 61k representing a file-shaped picture and characters reading “Keitai Remote.doc” and an image 611 representing a file-shaped picture and characters reading “MANUAL.pdf”. An area 59 marked “CLOSE” directly below the file server screen 50D is not an image based upon image data but is composed of characters displayed by the chat program.

By way of example, if image 61k of “Keitai Remote.doc” is clicked on the file server screen 50D of FIG. 23, the display changes over to the display of basic chat screen 50B illustrated in FIG. 24. An image 61m based upon new image data from which the file-shaped picture in the clicked image 61k of “Keitai Remote.doc” has vanished and in which the characters are reduced in size is displayed below the character entry box 51. The image 61m of “Keitai Remote.doc” may be created in the client terminal 21 or it may be so arranged that an image created in the image converter 10C is transmitted to the client terminal 21.

With reference to FIG. 25, also in a case where a message containing file information is transmitted, the message is entered in the character entry box 51, after which the transmission button 57 is clicked. As described above, the entered message, upon being converted to an image, is transmitted to the client terminals 21, 22 of chat users participating in the chat room.

In case of a message for which the attachment button 58 has been clicked followed by selection of a specific file name, unlike the sending and receiving of a message alone described above, an image file containing text data representing this message (data transmitted from the client terminals 21, 22 to the chat relay system 10) and image data obtained by converting this text data to an image in the image converter 10C includes, as link data, a path in the file server 40 regarding the selected file. Accordingly, a message image 61n (see FIG. 26) displayed on the client terminal 21 after transmission of the message containing the file information shown in FIG. 25 is clickable and is accompanied by link data that includes a path in the file server 40 regarding “Keitai Remote.doc”.

As illustrated in FIGS. 27 and 28, attendant upon the file selection by user A and message transmission, the message image 61n accompanied by the link data that includes the path in the file server 40 regarding “Keitai Remote.doc” is displayed on the basic chat screen 50B of client terminal 22 of user B.

(6) File View Processing

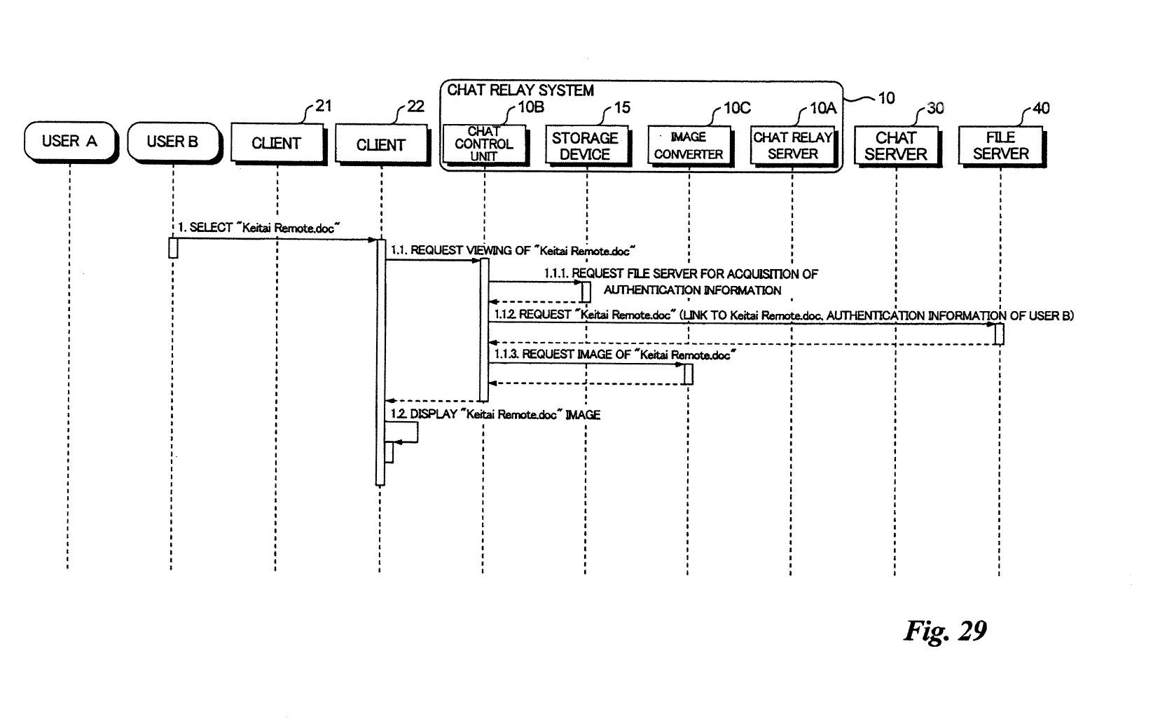

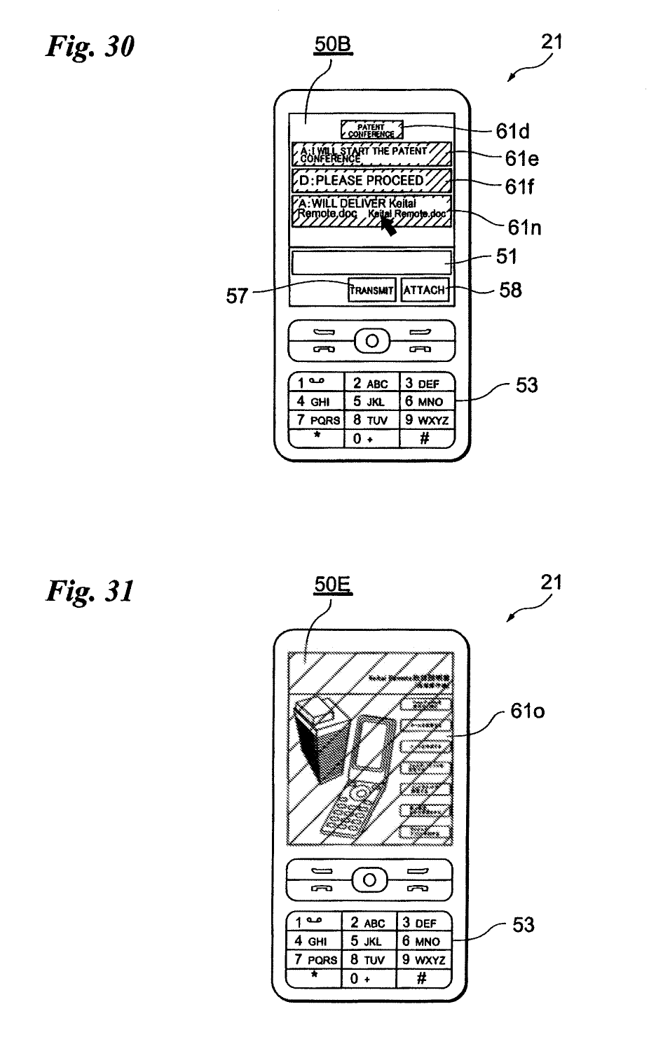

FIG. 29 is a sequence diagram illustrating processing executed by the client terminals, chat relay system, chat server and file server in processing for viewing a file. FIGS. 30 and 31 illustrate examples of screens displayed on the display unit of the client terminal 21 in file view processing.

For example, if the message image 61n with the accompanying link data including the path in the file server 40 regarding “Keitai Remote.doc” is clicked by user A or B (see FIG. 30), a message requesting viewing of Keitai Remote.doc is transmitted to the chat relay system 10 together with the user name. The view request message and the user ID are transmitted from the chat control unit 10B to the file server 40 (steps 1, 1.1, 1.1.1, 1.1.2 in FIG. 29).

Upon receiving the view request message, the file server 40 reads “Keitai Remote.doc” out of the storage device and transmits it to the chat relay system 10. The chat control unit 10B of chat relay system 10 transfers the received “Keitai Remote.doc” to the image converter 10C, which executes the image conversion. The image data representing the content of “Keitai Remote.doc” is transmitted to the client terminals 21, 22 and a file display screen 50E including an image 610 representing the content of “Keitai Remote.doc” is displayed (steps 1.1.3, 1.2 in FIG. 29) (see FIG. 31). Unlike the chat message image, the image based upon the file transmitted from the file server 40 displayed on the file display screen 50E is transmitted only to the client terminals that requested this file. Naturally, the image is transmitted to the client terminals of all users participating in the same chat room.

(7) Processing for Changing Display on Client Terminal

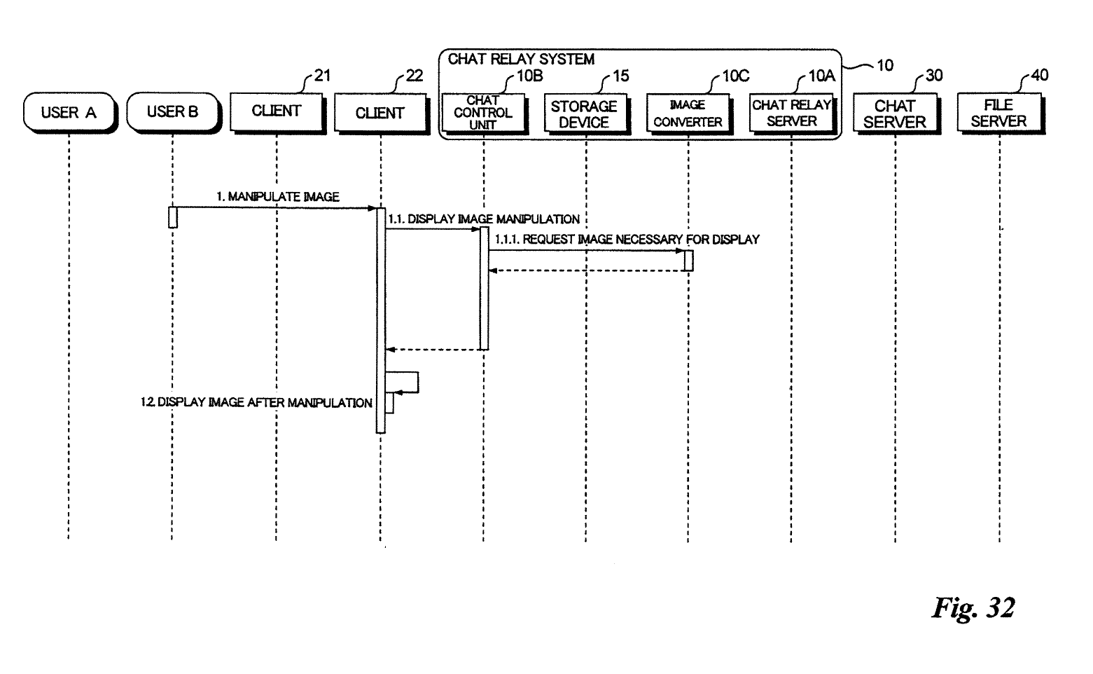

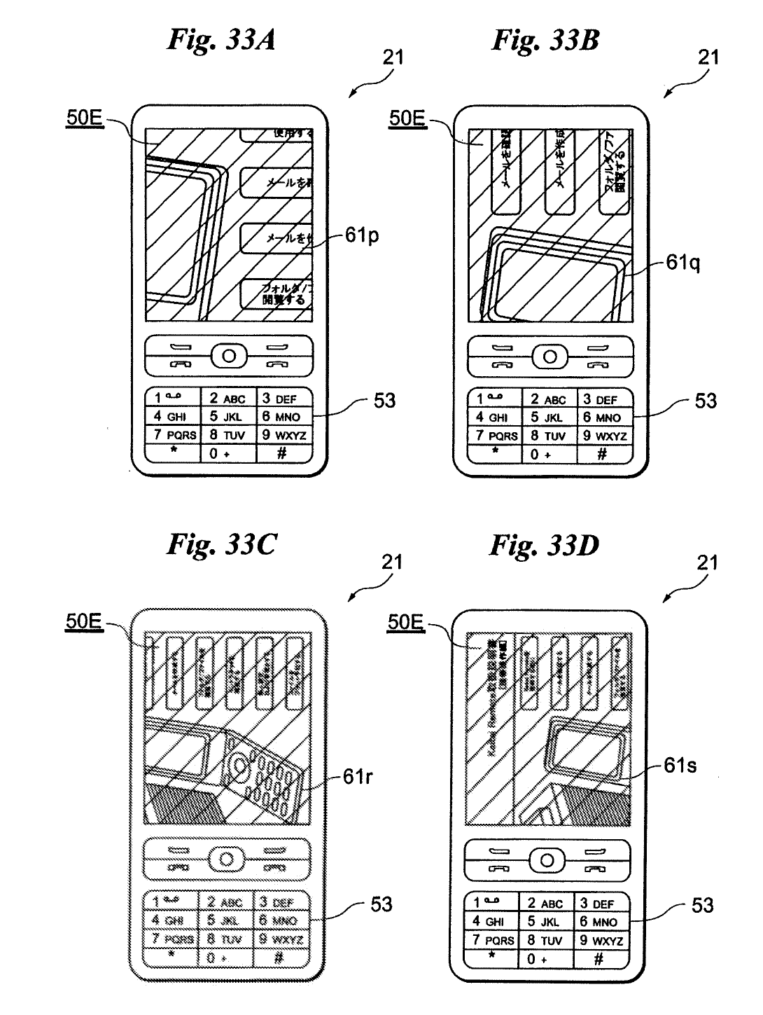

FIG. 32 is a sequence diagram illustrating processing executed by the client terminals, chat relay system, chat server and file server in processing for changing the display on a client terminal. FIGS. 33A to 33D illustrates examples of screens displayed on the display unit of client terminal 21 in processing for changing the display on the client terminal.

In a case where the image being displayed on the file display screen 50E of client terminal 21 is enlarged, rotated or moved, a message representing the content of this image processing and the image data being used in the image display on the file display screen 50E are transmitted from the client terminal 21 to the chat relay system 10 (steps 1, 1.1, 1.1.1 in FIG. 32). After image processing in line with this message is executed in the image converter 10C, the image data obtained by this image processing returns to the client terminal 21 (step 1.2). FIG. 33A is an example of display of an enlarged image 61p of image 610 shown in FIG. 31, FIG. 33B is an example of display of a rotated image 61q obtained by rotating the enlarged image 61p shown in FIG. 33A, FIG. 33C is an example of display of a rotated image 61r obtained by rotating the image 610 shown in FIG. 31, and FIG. 33D is an example of display of a moved image 61s obtained by moving the image 61r shown in FIG. 33C.

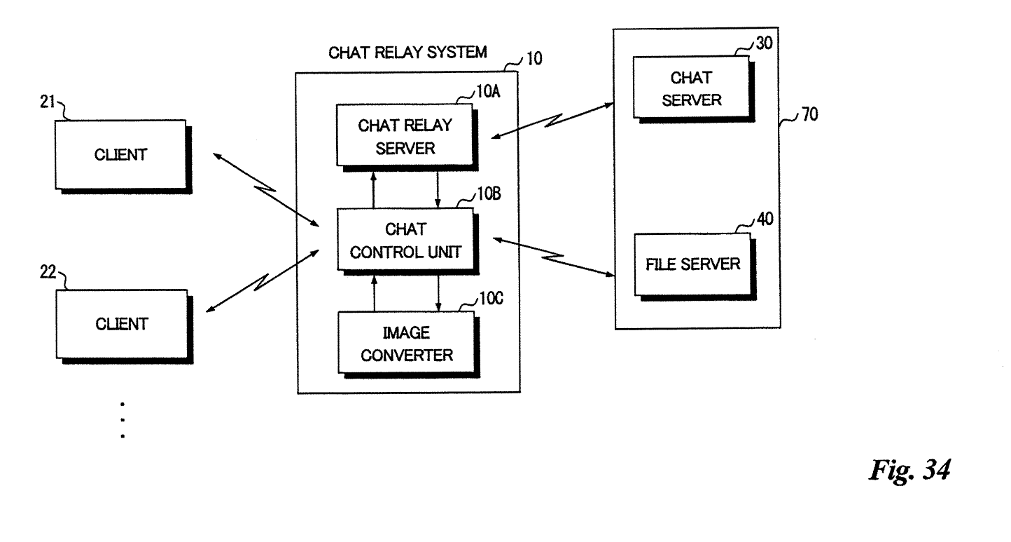

FIG. 34 is a block diagram illustrating the overall configuration of a chat system according to another embodiment that includes a chat relay system. This block diagram differs from the block diagram shown in FIG. 1 in that the chat server 30 and file server 40 are provided within a single LAN 70. Further, the LAN 70 and chat relay system 10 are connected by a VPN (dedicated network line, Virtual Private Network).

By constructing the chat server 30 and file server 40 within the LAN 70 and arranging it by way of the VPN so that there is no network connection other than that to the chat relay system 10, concealment of transmitted content and files that have been stored in the storage device of the file server 40 can be improved, thereby providing a more secure system.

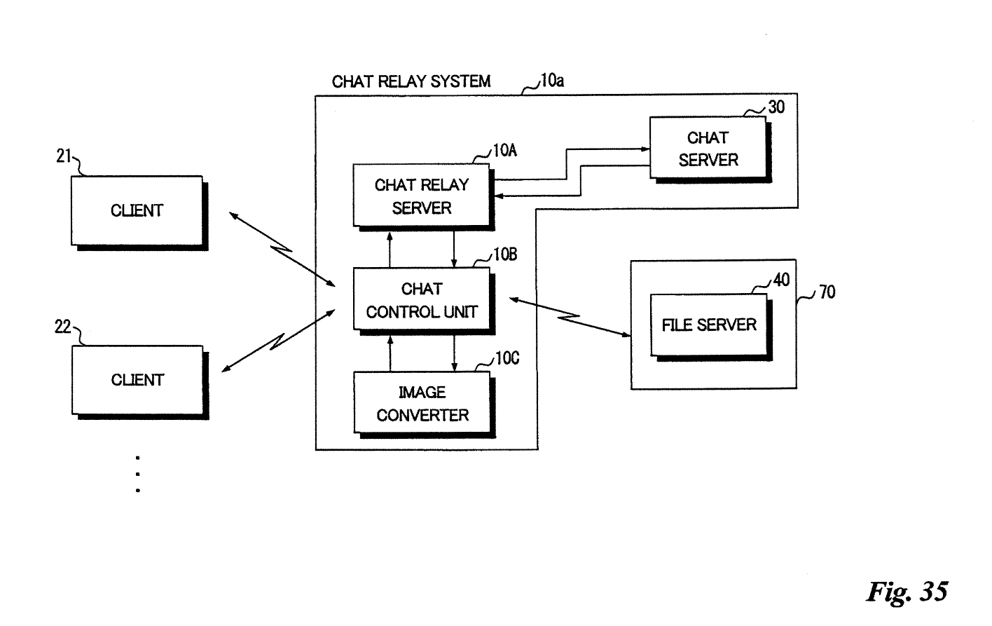

FIG. 35 is a block diagram illustrating the overall configuration of a chat system according to another embodiment that includes a chat relay system. This block diagram differs from the block diagram shown in FIG. 34 in that the chat server 30 is incorporated in a chat relay system 10a. Since data communication itself over a network between the chat server 30 and chat relay system 10 is eliminated, concealment of transmissions can be improved further. In this case where the chat server 30 is incorporated in the chat relay system 10a, a chat server program (a program that causes the chat relay system 10a to function as the chat server 30) is stored in the storage device 15 (FIG. 2) of the chat relay system 10a.

Finally, a scheme for sending and receiving messages in the chat system set forth above will be described.

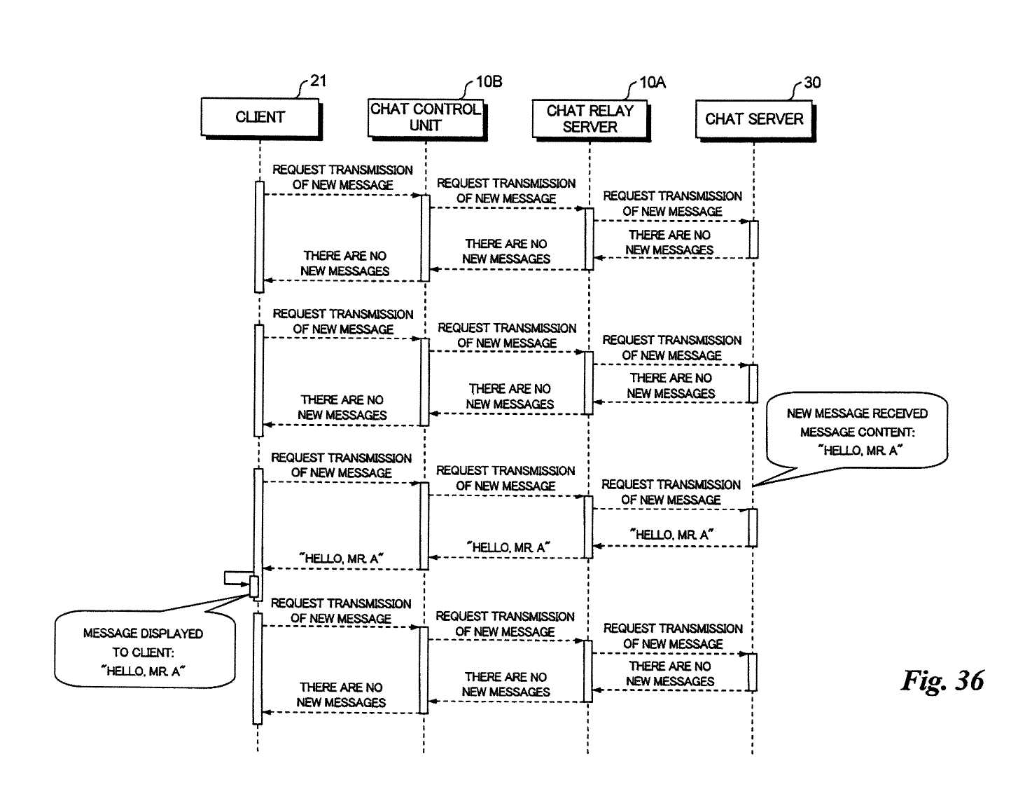

FIGS. 36, 37 and 38 are sequence diagrams illustrating three difference schemes for sending and receiving messages in the above-described chat system.

FIG. 36 illustrates a scheme (a polling scheme) whereby the client terminals 21, 22, . . . transmit a new-message transmit request to the chat server 30 at regular time intervals. According to this scheme, the chat server 30 executes processing (transmission of a message to client terminals 21, 22, . . . ) upon waiting for a request.

The chat server 30 that has received a request determines whether a message from client terminals 21, 22, . . . exists whenever the request is received. If a message does not exist, the chat server 30 transmits an indication of this fact to the client terminals 21, 22, . . . . If a message exists, then the chat server 30 transmits this message to the client terminals 21, 22, . . . participating in the chat.

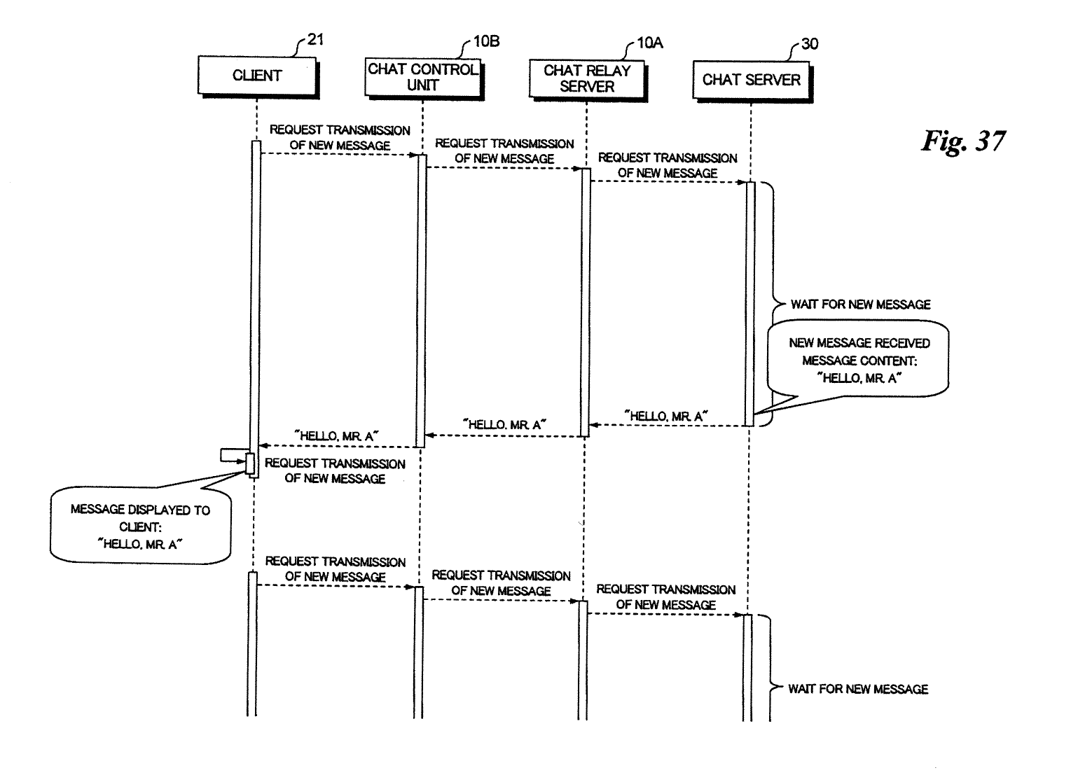

FIG. 37 illustrates a scheme (a Comet scheme) whereby the chat server 30 that has received a request retains this request until a response to the request becomes possible and responds to the request when the response has become possible. When a new-message transmit request transmitted from the client terminals 21, 22, . . . is received by the chat server 30, the latter stands by until the message is received. When the message is received, the chat server 30 transmits the message to the client terminals 21, 22, . . . as a response to the new-message transmit request.

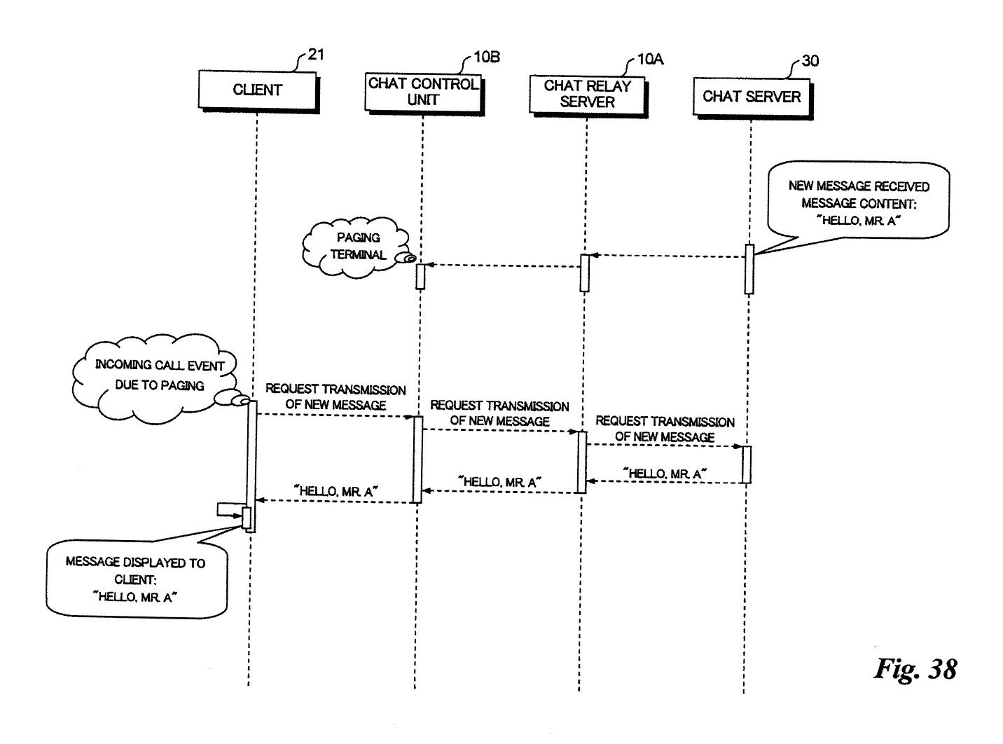

FIG. 38 illustrates a scheme (a paging scheme) whereby the chat server, upon receiving a message, transmits paging data to the client terminals 21, 22, . . . , in accordance with which the client terminals 21, 22, . . . are caused to transmit a new-message transmit request. Upon receiving a message, the chat server 30 sends an indication to this effect to the chat control unit 10B via the chat relay server 10A, and the chat control unit 10B transmits paging data to the client terminals 21, 22, . . . . The paging data may be an incoming call or an e-mail transmission, etc. Upon being made aware by the receipt of paging data that a message exists, the user transmits a new-message transmit request to the chat server 30 using the client terminal.

The chat system of the embodiments may employ any scheme among the above-mentioned polling, Comet and paging schemes.

As many apparently widely different embodiments of the present invention can be made without departing from the spirit and scope thereof, it is to be understood that the invention is not limited to the specific embodiments thereof except as defined in the appended claims.

What is claimed is:

1. A chat relay system, which is provided between a chat terminal and a chat server, for relaying a chat message transmitted from the chat terminal toward the chat server and a chat message transmitted from the chat server toward the chat terminal, said system comprising:
an image converter for converting a text-data chat message, which is transmitted from the chat server to the chat terminal, to an image-data chat message image; and
an image transmission control unit for transmitting image data, which represents the chat message image obtained by data conversion performed by said image converter, to the chat terminal in place of the text data representing the chat message.

2. The system according to claim 1, wherein the image data is associated with link information;
said image converter converts, to an image-data document image, a document file containing text data transmitted from an external device toward the chat terminal in accordance with this link information; and
said image transmission control unit transmits the image data of the document image obtained by the data conversion by said image converter to the chat terminal in place of the text data representing the document file.

3. A chat terminal used in a chat system including the chat terminal, a chat server and a chat relay system, which is provided between the chat terminal and the chat server, for relaying a chat message transmitted from the chat terminal toward the chat server and a chat message transmitted from the chat server toward the chat terminal, said chat terminal comprising:
a chat message transmitting device for transmitting a text-data chat message;
a chat message image receiving device for receiving chat message image data, which represents a chat message image that is the result of converting a text-data chat message to an image, obtained by data conversion processing in the chat relay system with regard to a chat message transmitted from the chat server toward said chat terminal; and
a chat message image display device for displaying the chat message image represented by the chat message image data received by said chat message image receiving device.

4. The chat terminal according to claim 3, wherein said chat message receiving device attaches link information to and transmits this information together with the text-data chat message;
said chat message image receiving device receives chat message image data representing a chat message image that is the result of converting the text-data chat message to an image, and the link information, which has been associated with the chat message image data, obtained when the link information has been attached to the text-data chat message in the chat relay system; and
said chat message image display device, in response to receipt of the chat message image data with which the link information has been associated, displays the chat message image, which is represented by the chat message image data, in clickable fashion in such a manner that the chat message transmitting device will transmit data that is in accordance with the link information when the chat message image is clicked.

5. A method of controlling a chat relay system, which is provided between a chat terminal and a chat server, for relaying a chat message transmitted from the chat terminal toward the chat server and a chat message transmitted from the chat server toward the chat terminal, the chat relay system including an image converter and an image transmission control unit, and said method comprising the steps of:
the image converter converting a text-data chat message, which is transmitted from the chat server to the chat terminal, to an image-data chat message image; and
the image transmission control unit transmitting image data, which represents the chat message image obtained by data conversion performed by the image converter, to the chat terminal in place of the text data representing the chat message.

6. A method of controlling a chat terminal used in a chat system including the chat terminal, a chat server and a chat relay system, which is provided between the chat terminal and the chat server, for relaying a chat message transmitted from the chat terminal toward the chat server and a chat message transmitted from the chat server toward the chat terminal, said method comprising the step of controlling the chat terminal so as to:
transmit a text-data chat message;
receive chat message image data, which represents a chat message image that is the result of converting a text-data chat message to an image, obtained by data conversion processing in the chat relay system with regard to a chat message transmitted from the chat server toward the chat terminal; and
display the chat message image represented by the chat message image data received.

7. A chat system comprising:
a chat terminal having an input unit for accepting input of a text-data chat message; a chat message transmitting device for transmitting the text-data chat message received from the input unit; an image data receiving device for receiving image data; and a display unit for displaying an image represented by the image data received by the image data receiving device;
a chat server having a chat message receiving device for receiving a text-data chat message transmitted from said chat terminal; and a chat message distributing device for distributing the chat message, which has been received by the chat message receiving device, to a chat terminal of a chat participating user;
a file server having a storage device for storing a document file; and
a chat relay system for relaying transmission and reception of data between said chat terminal and said chat server and transmission and reception of data between said chat terminal and said file server;
wherein said chat relay system includes an image converter for converting a text-data chat message, which is transmitted from said chat server to said chat terminal, to an image-data chat message image, and for converting a document file, which is transmitted from said file server to said chat terminal, to an image-data document image.

8. The system according to claim 7, wherein said chat server and said file server are connected with said chat relay system by a dedicated network.

9. The system according to claim 7, wherein said chat server is included in said chat relay system.

10. The system according to claim 7, wherein reception and transmission of a chat message between said chat terminal and said chat server is carried out by a polling scheme, in which said chat terminal transmits a new-message transmit request to said chat server repeatedly at prescribed time intervals and said chat server transmits a reply to the request to said chat terminal whenever it receives the transmit request.

11. The system according to claim 7, wherein reception and transmission of a chat message between said chat terminal and said chat server is carried out by a Comet scheme, in which a new-message transmit request transmitted from said chat terminal to said chat server continues to be held until said chat server is capable of replying to the request, and said chat server transmits the reply to said chat terminal at a timing at which the reply to the request has become possible.

12. The system according to claim 7, wherein reception and transmission of a chat message between said chat terminal and said chat server is carried out by a paging scheme, in which said chat server, in response to receipt of a text-data chat message transmitted from said chat terminal, transmits paging data to said chat terminal of the chat participating user, and a new-message transmit request is transmitted from said chat terminal to said chat server in response to receipt of the paging data.
